(19) United States
(12) Patent Application Publication
(10) Pub. No.: US 2026/0361819 A1
(43) Pub. Date: Nov. 12, 2026

(54) System and Method for Campaign-Controlled Mobile Wallet Offer Delivery and Lifecycle Management

(71) Applicant: TapText llc, Coral Springs, FL (US)

(72) Inventors: Steve Doumar, Fort Lauderdale, FL (US); David Teodosio, Guilford, CT (US); Brian Galvin, Silverdale, WA (US)

(21) Appl. No.: 19/748,053

(22) Filed: Jul. 20, 2026

Related U.S. Application Data
(63) Continuation-in-part of application No. 19/696,642, filed on Jun. 3, 2026.
Application No. 19/696,642 is a continuation-in-part of application No. 19/683,929, filed on May 21, 2026.
Application No. 19/683,929 is a continuation-in-part of application No. 19/441,824, filed on Jan. 6, 2026.
Application No. 19/441,824 is a continuation of application No. 17/874,209, filed on Jul. 26, 2022, now Pat. No. 12,519,888.
Application No. 17/874,209 is a continuation-in-part of application No. 17/865,814, filed on Jul. 15, 2022, now Pat. No. 12,211,070.
Application No. 17/865,814 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
Application No. 19/696,642 is a continuation-in-part of application No. 18/631,042, filed on Apr. 10, 2024, now Pat. No. 12,657,570.
Application No. 18/631,042 is a continuation-in-part of application No. 18/593,911, filed on Mar. 3, 2024, now Pat. No. 12,182,794.
Application No. 18/593,911 is a continuation-in-part of application No. 18/185,993, filed on Mar. 17, 2023, now Pat. No. 11,995,639.
Application No. 18/185,993 is a continuation of application No. 17/409,841, filed on Aug. 24, 2021, now Pat. No. 11,610,193.
Application No. 17/409,841 is a continuation-in-part of application No. 17/360,731, filed on Jun. 28, 2021, now Pat. No. 11,871,308.
Application No. 17/360,731 is a continuation-in-part of application No. 17/229,251, filed on Apr. 13, 2021, now abandoned.
(63) Continuation-in-part of application No. 18/768,456, filed on Jul. 10, 2024, now Pat. No. 12,689,522.
Application No. 18/768,456 is a continuation of application No. 18/154,816, filed on Jan. 14, 2023, now Pat. No. 12,047,515.
Application No. 18/154,816 is a continuation-in-part of application No. 17/942,227, filed on Sep. 12, 2022, now Pat. No. 12,158,938.
(60) Provisional application No. 63/154,357, filed on Feb. 26, 2021.
(60) Provisional application No. 63/166,391, filed on Mar. 26, 2021.
(60) Provisional application No. 63/211,496, filed on Jun. 16, 2021.
(60) Provisional application No. 63/319,314, filed on Mar. 12, 2022.
(60) Provisional application No. 63/399,631, filed on Aug. 19, 2022.
(60) Provisional application No. 63/519,562, filed on Aug. 14, 2023.
(60) Provisional application No. 63/519,559, filed on Aug. 14, 2023.

(51) Int. Cl. H04M 3/51; H04L 51/02; H04M 1/72436

(52) U.S. Cl. CPC H04M 3/5191; H04L 51/02; H04M 1/72436

(57) ABSTRACT

A system and method for campaign-controlled mobile wallet offer delivery and lifecycle management are disclosed. A user interacts with an activation asset, causing a user device to transmit an initial message received by a messaging gateway. The platform captures one or more user-or device-associated identifiers, resolves campaign and offer context, and selects a configured wallet offer through an interaction control server. The system determines device-ecosystem compatibility and generates a wallet pass or wallet object appropriate to the user's wallet environment. A controlled wallet delivery link is transmitted to the user, resolving to a dynamic enrollment surface through which installation is completed. After installation, the platform maintains an association between the installed wallet object and persistent identity, campaign, session, and lifecycle records. The system supports redemption tracking, pass updates, expiration, revocation, replacement, duplicate prevention, and follow-on communications, transforming the installed wallet artifact into a managed and continuously governed platform object.

### CROSS-REFERENCE TO RELATED APPLICATIONS

Priority is claimed in the application data sheet to the following patents or patent applications, each of which is expressly incorporated herein by reference in its entirety:
Ser. No. 19/696,642
Ser. No. 19/683,929
Ser. No. 19/441,824
Ser. No. 17/874,209
Ser. No. 17/865,814
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
Ser. No. 18/631,042
Ser. No. 18/593,911
63/519,562
Ser. No. 18/185,993
Ser. No. 17/409,841
Ser. No. 17/360,731
Ser. No. 17/229,251
63/211,496
63/519,559
Ser. No. 18/768,456
Ser. No. 18/154,816
Ser. No. 17/942,227
63/319,314
63/399,631

### BACKGROUND OF THE INVENTION

### Field of the Art

The present invention relates to the field computer-based communication systems, and more specifically to digital-wallet-integrated customer offer and campaign management.

Discussion of the State of the Art

Mobile wallet platforms such as Apple Wallet and Google Wallet provide device-resident environments in which passes, offers, tickets, and loyalty artifacts may be stored and presented at points of interaction. Standards and protocols exist for packaging and delivering wallet passes, and various businesses have adopted wallet-based distribution as a channel for promotional content. However, existing implementations generally treat wallet pass delivery as a terminal action in which a pre-authored pass file is exposed through a static link or generic landing page, without meaningful integration into a broader campaign, identity, or communication architecture. The wallet artifact is typically distributed as a standalone object with no durable association to the platform that issued it, the user identity that received it, or the session through which it was obtained.

Messaging platforms have matured considerably in their ability to initiate and manage user engagement flows. Short message service, multimedia messaging service, and richer messaging protocols provide mechanisms through which businesses may reach users on their mobile devices, capture identifiers, and deliver controlled responses. Some implementations combine messaging with promotional links or offer pages. However, the transition from a messaging interaction to a wallet-installed object remains technically underdeveloped in the existing art. Existing systems do not generally integrate messaging-driven engagement flows with runtime wallet offer selection, device-ecosystem-aware provisioning, or identity-linked pass management in a unified architecture. The link between a messaging event and a resulting wallet artifact is typically shallow, one-directional, and devoid of the session continuity and identity association that would be needed to support ongoing platform governance of the installed object.

Device-ecosystem diversity presents an additional challenge that existing systems address only superficially. A user operating an Apple device requires a different provisioning path and pass format than a user operating an Android device, yet most existing offer-delivery systems address this through ad hoc dual-button pages or client-side branching logic that is disconnected from any broader campaign or identity framework. No durable record of the ecosystem determination is generally preserved, and the determination itself does not inform later lifecycle decisions, update logic, or follow-on communication strategies. A technically coherent and identity-aware approach to device-ecosystem compatibility determination remains absent from the existing art.

The lifecycle of an installed wallet object presents a further gap. Once a pass is installed on a device, conventional systems have limited capacity to track its redemption state, push updates to its fields, enforce expiration or revocation, prevent duplicate issuance, or coordinate follow-on communications based on its current condition. The pass is treated as a delivered artifact rather than as a managed and stateful platform object. Redemption events, when captured at all, are typically handled by point-of-sale or venue systems without being tied back to the originating campaign interaction, messaging session, or user identity record in a reliable or structured way.

There accordingly remains a need for a system in which wallet offer delivery is initiated through a structured messaging flow, governed by campaign and identity state, adapted to device-ecosystem compatibility at runtime, and extended through continuing lifecycle management of the installed wallet object. Such a system should preserve session and identity continuity from the moment of activation-asset interaction through installation, redemption, update, and expiration, treating the wallet artifact not as a passive downloadable file but as a managed and platform-associated object within a broader campaign-controlled engagement architecture.

### SUMMARY OF THE INVENTION

According to a preferred embodiment, a system for campaign-controlled mobile wallet offer delivery and lifecycle management, the system comprising: one or more processors and one or more non-transitory computer-readable media storing instructions that, when executed, cause the system to perform operations comprising: receiving, at a messaging gateway, an inbound message or interaction event originating from a user device in response to user interaction with an activation asset, and capturing one or more user-or device-associated identifiers from the inbound message or interaction event; retrieving or creating, by an interaction control server, a persistent identity record associated with the captured identifier, and resolving one or more campaign or offer contexts associated with the activation asset; selecting, by the interaction control server, a wallet offer from one or more configured wallet offer records based at least in part on the resolved campaign or offer context and the persistent identity record; determining, by a device-ecosystem compatibility service, a wallet ecosystem associated with the user device, and generating or selecting a wallet provisioning path appropriate to the determined wallet ecosystem; transmitting, to the user device, a response message comprising a controlled wallet delivery link resolving to a dynamic enrollment surface through which a wallet pass or wallet object corresponding to the selected wallet offer may be installed into the determined wallet ecosystem; and maintaining, by a wallet lifecycle manager, an association between the installed wallet pass or wallet object and one or more of the persistent identity record, a campaign record, a session identifier, and a lifecycle state record, such that the platform retains the ability to track, update, and govern the wallet pass or wallet object after installation.

According to another preferred embodiment, a method for campaign-controlled mobile wallet offer delivery and lifecycle management, the method comprising the steps of: receiving an inbound message or interaction event originating from a user device in response to user interaction with an activation asset, and capturing one or more user-or device-associated identifiers from the inbound message or interaction event, using a messaging gateway; retrieving or creating a persistent identity record associated with the captured identifier, and resolving one or more campaign or offer contexts associated with the activation asset, using an interaction control server; selecting a wallet offer from one or more configured wallet offer records based at least in part on the resolved campaign or offer context and the persistent identity record, using an interaction control server; determining a wallet ecosystem associated with the user device, and generating or selecting a wallet provisioning path appropriate to the determined wallet ecosystem, using a device-ecosystem compatibility service; transmitting, to the user device, a response message comprising a controlled wallet delivery link resolving to a dynamic enrollment surface through which a wallet pass or wallet object corresponding to the selected wallet offer may be installed into the determined wallet ecosystem; and maintaining an association between the installed wallet pass or wallet object and one or more of the persistent identity record, a campaign record, a session identifier, and a lifecycle state record, such that the platform retains the ability to track, update, and govern the wallet pass or wallet object after installation, using a wallet lifecycle manager.

### BRIEF DESCRIPTION OF THE DRAWING FIGURES

FIG. 1 is a system diagram illustrating an exemplary architecture for campaign-controlled mobile wallet offer delivery and lifecycle management.

FIG. 2 is a method diagram illustrating interaction with a call to action or activation asset that initiates a messaging-driven wallet offer flow.

FIG. 3 is a method diagram illustrating the wallet offer selection logic executed by the interaction control server upon receipt of a provisioning context from the initiation flow.

FIG. 4 is a block diagram illustrating an exemplary wallet offer configuration service and associated wallet offer datastore, together with the downstream offer selection service and provisioning context object to which configured offer data is supplied.

FIG. 5 is a block diagram illustrating an exemplary wallet provisioning service configured to receive a provisioning context object and generate, package, and deliver a wallet pass or wallet object appropriate to the user's device ecosystem.

FIG. 6 is a method diagram illustrating device-ecosystem compatibility determination and the selection between alternative wallet installation paths.

FIG. 7 is a method diagram illustrating the dynamic wallet enrollment URL and provisioning surface through which a user proceeds from activation of a controlled wallet delivery link to initiation of wallet pass installation.

FIG. 8 is a message flow diagram illustrating the interactions among a interaction control server, a wallet provisioning service, and a wallet offer datastore, according to a preferred embodiment.

FIG. 9 is a block diagram illustrating the associations among the core data records and state indicators that collectively constitute the platform's identity-linked wallet association architecture.

FIG. 10 is a state diagram illustrating the wallet object lifecycle state machine, depicting the full set of states through which a wallet pass or wallet object may pass from initial generation through terminal or replacement conditions, together with the transitions that govern movement between those states.

FIG. 11 is a method diagram illustrating the redemption and usage tracking flow through which the platform receives, validates, and processes a usage event reported by a downstream system, updates the lifecycle state of the associated pass instance, and determines whether one or more follow-on actions should be triggered.

FIG. 12 is a method diagram illustrating the pass update, expiration, revocation, and replacement flow through which the platform executes platform-side lifecycle actions against an installed wallet artifact in response to internally or externally generated triggers.

FIG. 13 is a system diagram illustrating the downstream integration architecture through which the interaction control server and wallet lifecycle manager exchange data, according to a preferred embodiment.

FIG. 14 illustrates an exemplary computing environment on which an embodiment described herein may be implemented.

### DETAILED DESCRIPTION OF THE INVENTION

The present invention provides a system and method for campaign-controlled mobile wallet offer delivery and lifecycle management. In preferred embodiments, the invention enables a user to move from an interaction with a physical or digital activation asset into a messaging-driven engagement flow in which the platform selects, configures, and delivers a mobile wallet offer for installation on the user's device, and thereafter maintains the installed wallet artifact as a managed, identity-linked, and continuously governable platform object. The disclosed system differs from conventional wallet offer distribution approaches in that the wallet artifact is not treated as a static coupon file, a generic pass download, or a terminal endpoint in the interaction sequence. Instead, it is selected, provisioned, installed, and governed as a controlled object whose condition, content, and lifecycle are at all times subject to platform-side intelligence informed by campaign state, user identity, session context, device ecosystem compatibility, and downstream event signals.

A user may encounter an activation asset in a wide variety of physical or digital environments, including a QR code displayed at a live venue, a redirect link embedded in a digital advertisement, a clickable control within a message, or a code presented on signage or a jumbotron display. Interaction with the activation asset causes the user's device to generate and transmit an initial message or interaction event, typically a pre-filled SMS or MMS message carrying one or more identifiers associated with the originating campaign or offer context. This message is received by a messaging gateway, which captures one or more user-or device-associated identifiers—most commonly the phone number of the transmitting device—and routes the interaction to an interaction control server for processing. The use of a messaging-driven initiation mechanism is significant because it allows the platform to capture a stable user identifier and establish a session record at the very outset of the interaction, without requiring the user to complete a manual registration form, download a dedicated application, or navigate a complex enrollment sequence. The resulting session record links the activation asset, the captured identifier, and the resolved campaign context into a coherent and traceable thread that governs all subsequent platform actions.

Upon receiving the initial message or interaction event, the interaction control server retrieves or creates a persistent identity record associated with the captured user identifier and resolves the campaign and offer context associated with the originating activation asset. The interaction control server then selects an appropriate wallet offer from one or more configured offer records maintained in a wallet offer datastore, evaluating a combination of campaign state, user identity, prior interaction history, venue or event context, and loyalty state to determine what offer is most appropriate for the current user at the current moment. The selected wallet offer is not necessarily a generic promotional artifact applied uniformly to all users who interact with the same activation asset. Rather, it may be a user-specific or session-specific instance derived from a reusable offer template, reflecting the particular context, history, and eligibility characteristics of the individual user. Where a prior offer instance associated with the same user and campaign context is found on record, the platform may determine that an update, a replacement, or a reactivation is more appropriate than a fresh issuance, thereby avoiding blind redelivery of identical content and ensuring that the offer presented to the user is always contextually relevant and lifecycle-appropriate.

The platform simultaneously evaluates the device ecosystem compatibility of the user's device, consulting device environment signals, browser characteristics, operating system indicators, and prior identity-linked capability records to determine whether the user's device corresponds to a first wallet ecosystem, such as an Apple wallet environment, or a second wallet ecosystem, such as a Google wallet environment. This determination governs the provisioning path that the platform will use to generate and package the wallet artifact, ensuring that the resulting pass or wallet object is technically compatible with the destination wallet environment on the user's device. A response message is then transmitted to the user containing a controlled wallet delivery link that resolves to a dynamic enrollment surface—not a static landing page, but a runtime-controlled provisioning interface whose content, available installation paths, and behavioral logic are all determined by the platform-side context assembled during the offer selection and ecosystem determination process. The dynamic enrollment surface verifies validity conditions, presents the offer to the user for confirmation, and exposes the device-appropriate installation mechanism through which the user may add the wallet pass or wallet object to their device's wallet environment.

The wallet provisioning service generates and packages the wallet artifact by mapping the selected offer's configured field values into the technical format required by the target wallet ecosystem, constructing a unique and individually identified pass instance carrying serial numbers, barcode payloads, and session-linked tokens that associate the resulting artifact with specific backend records, and exposing the packaged artifact through a dynamic enrollment URL or installable payload. The uniqueness of the pass instance is architecturally significant because it is the individual instance identifier that enables the platform to track installation, detect duplicate issuance attempts, attribute redemption events, deliver field updates, and enforce expiration and revocation for the specific issued artifact rather than for the offer category as a whole. A backend instance record is initialized at the time of provisioning, capturing the pass instance's identity associations, campaign context, device ecosystem, and initial lifecycle state, and establishing the record against which all subsequent lifecycle events will be tracked and governed.

After the wallet pass or wallet object has been installed on the user's device, the platform's wallet lifecycle manager maintains a continuing association between the installed artifact and the persistent identity, campaign, session, and lifecycle records established during the initiation and provisioning flow. This continuing association is what allows the platform to treat the installed wallet object as a managed and stateful platform artifact rather than a disconnected device-local file. The lifecycle manager tracks the pass instance through a defined set of lifecycle states—including generated, offered, pre-installation, installed, updated, redeemed, expired, revoked, and replacement issued—and governs transitions between those states in response to a variety of triggering events. Installation confirmation events, redemption signals reported by downstream systems, platform-side update instructions, expiration conditions, and fraud or duplication findings each represent potential triggers for lifecycle state transitions, and the platform's response to each such trigger is governed by the campaign rules, offer terms, and identity context associated with the specific pass instance involved.

The platform's redemption and usage tracking capabilities allow it to receive usage events from a wide range of downstream systems—including point-of-sale platforms, venue scanners, loyalty engines, and external APIs—and to associate each received event with the correct pass instance and identity record through the machine-readable identifiers embedded in the wallet artifact at the time of provisioning. Validated redemption events trigger lifecycle state transitions, identity and campaign record updates, and, where appropriate, follow-on actions such as thank-you messages, replacement pass issuances, loyalty accrual notifications, or cross-sell communications. The platform's pass update capability allows field-level changes to be pushed to installed wallet artifacts in response to loyalty state changes, event modifications, revised validity periods, or campaign operator instructions, keeping the device-resident wallet object current and meaningful without requiring the user to reinstall or re-enroll. Where revocation or expiration is warranted, the platform may invalidate the pass instance and, where appropriate, issue a replacement pass to the same user, initiating a new lifecycle cycle while preserving the identity and campaign associations of the original issuance. Throughout all of these post-installation lifecycle operations, the platform exchanges lifecycle events, redemption confirmations, attribution data, and state updates bidirectionally with downstream integration systems including CRM platforms, loyalty systems, venue and point-of-sale systems, analytics engines, and external APIs, ensuring that the wallet artifact's lifecycle remains connected to the broader business system landscape in which it operates and that the originating campaign retains full attribution intelligence from the moment of activation-asset interaction through the final disposition of the installed wallet object.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

Activation Asset. An activation asset is a physical or digital engagement initiator—such as a Quick Response (“QR”) code, Near Field Communication (“NFC”) tag, redirect link, call-to-action button, or venue-displayed code—that is associated with a specific campaign or offer context and is configured such that user interaction with it causes a user device to generate and transmit an initial message or interaction event to the platform. The activation asset serves as the entry point into the platform's wallet provisioning flow and is architecturally significant because it encodes sufficient contextual information to identify the originating campaign, client, venue, or event context without requiring the user to manually enter identifying information or navigate a registration interface. The value of the activation asset as an engagement mechanism derives not merely from its role as a trigger for user action, but from its function as a structured carrier of campaign context: the identifiers and payload values associated with the asset at the time of configuration determine the precision with which the platform can subsequently select, personalize, and deliver an appropriate wallet offer. In embodiments where the activation asset causes the user device to auto-populate a pre-filled outbound message, the platform receives a structured inbound event that binds the user's captured identifier to the originating campaign context in a single, friction-minimal interaction step. The activation asset may be deployed across a wide range of physical and digital environments, including live venues, printed marketing materials, digital advertisements, signage displays, and embedded controls within messages or web pages, and a single campaign may employ multiple activation assets distributed across different locations or channels while each resolves to the same campaign context within the platform.

Persistent Identity Record. A persistent identity record is a durable, platform-maintained data structure associated with a specific user-device identifier—most commonly a phone number—that accumulates and preserves contextual intelligence about that user across multiple sessions, campaigns, interactions, and wallet offer lifecycle events. The persistent identity record is created or retrieved by the interaction control server at the outset of each platform engagement, and its availability transforms each new user interaction from an anonymous event into a contextually informed, history-aware transaction. The record may capture, over time, prior campaign interactions and their outcomes, previously issued wallet pass instances and their current lifecycle states, device ecosystem observations and capability signals, redemption history, loyalty state, opt-in and permission status, and any other behavioral or demographic attributes that the platform accumulates through the course of the user's engagement with the system. The persistence of the record across sessions is what enables the platform to avoid duplicate issuance of wallet artifacts, to recognize returning users and offer contextually appropriate updates or replacements in lieu of fresh issuances, to enforce campaign-level eligibility conditions that depend on prior interaction history, and to coordinate follow-on communications based on the accumulated relationship between the user and the platform. The phone number or other stable device-associated identifier that anchors the persistent identity record is significant because it constitutes a reliable, carrier-verified identity anchor that cannot easily be spoofed or fabricated, enabling the platform to maintain continuity of identity across device changes, session gaps, and varying interaction modalities without requiring the user to create or manage explicit account credentials.

Wallet Offer. A wallet offer is a structured, platform-managed promotional artifact configured for delivery to and installation within a mobile wallet environment on a user's device, comprising a defined set of field values, branding assets, validity parameters, barcode or serial data, and redemption rules that collectively specify the content, appearance, and behavioral properties of the resulting installed wallet pass or wallet object. A wallet offer as used in this invention differs from a conventional static coupon or promotional file in that it is not a pre-authored, uniformly distributed artifact but a runtime-selected, identity-aware, and campaign-governed construct that may be instantiated differently for different users, sessions, or interaction contexts based on the offer selection logic applied by the platform. Wallet offers are maintained in configured form within the wallet offer datastore and may be organized as reusable offer templates from which user-specific or session-specific pass instances are derived at the time of provisioning. A single wallet offer template may yield many distinct pass instances, each assigned unique identifiers that associate the resulting artifact with a specific user, session, and issuance event and enable the platform to track, update, and govern that artifact independently of all others derived from the same template. The wallet offer encompasses the full specification of what the user will see and interact with on their device—including the visual identity, field labels and values, machine-readable payload, validity window, and any dynamic fields that may be updated after installation—as well as the backend rules and lifecycle policies that govern how the offer may be redeemed, updated, expired, or replaced over the course of its active lifecycle.

Pass Instance. A pass instance is an individually identified wallet artifact generated from a wallet offer definition and associated with a specific user identity record, session identifier, and campaign context at the time of provisioning, constituting the discrete unit of platform-managed object that is delivered to a user's device, tracked through installation and use, and governed across its full lifecycle by the wallet lifecycle manager. Each pass instance is assigned one or more unique identifiers—such as a serial number, barcode payload, or session-linked token—that distinguish it from all other instances derived from the same offer template and enable the platform to address, update, and reason over that specific artifact independently. The creation of a unique pass instance for each provisioning event is architecturally foundational to the platform's lifecycle management capabilities: it is the individual instance identifier that allows the system to confirm installation, detect duplicate issuance attempts, attribute redemption events to specific users and campaigns, deliver targeted field updates, and enforce expiration or revocation for the specific issued artifact rather than for the offer category as a whole. A backend pass instance record is initialized at provisioning time, capturing the instance's identity associations, device ecosystem, campaign context, and initial lifecycle state, and this record serves as the authoritative reference against which all subsequent lifecycle events—including installation confirmation, redemption, update, expiration, and replacement—are tracked and attributed. The distinctness of each pass instance is what enables the platform to treat the wallet artifact not as an anonymous device-local file but as a known, individually governed platform object whose current condition is at all times observable and controllable from the platform side.

Device-Ecosystem Compatibility Service. The device-ecosystem compatibility service is a platform component responsible for determining, at runtime and with sufficient confidence to govern provisioning decisions, which mobile wallet environment is associated with a user's device, and for routing the wallet artifact generation and delivery flow into the technically appropriate path for that environment. This determination is necessary because different classes of user devices support fundamentally incompatible wallet environments—principally a first wallet ecosystem associated with Apple devices and a second wallet ecosystem associated with Android devices—each requiring distinct pass formats, packaging conventions, installation mechanisms, and API integrations that cannot be served by a single unified output. The device-ecosystem compatibility service collects and evaluates multiple categories of device environment signals observable at the time the user activates the wallet delivery link, including device type, mobile operating system, browser identity and version, user-agent values, and application container characteristics, and may supplement these current signals with prior identity-linked capability records accumulated during earlier platform interactions involving the same user. Where the collected signals permit a high-confidence determination, the service routes the provisioning flow to the appropriate ecosystem-specific path without requiring user action. Where signals are ambiguous or insufficient to reach a confident conclusion, the service may present both installation paths to the user simultaneously, allowing the user to manually select the applicable wallet environment. The ecosystem determination produced by this service is not merely a routing decision but a governing input to the wallet provisioning service, as it determines what format and packaging the wallet artifact will be generated in and therefore directly controls whether the resulting pass will be installable on the user's device.

Dynamic Enrollment Surface. A dynamic enrollment surface is a runtime-controlled provisioning interface—distinct from a static landing page or generic offer page—through which a user proceeds from activation of a controlled wallet delivery link to initiation of wallet pass installation, whose content, available installation paths, validity enforcement behavior, and presentational elements are all determined at the moment of access by platform-side logic evaluated against the current session, identity, and offer context. The dynamic nature of the enrollment surface is architecturally significant because it ensures that each user's installation experience reflects the specific circumstances of their interaction rather than presenting a uniform experience indifferent to identity, lifecycle state, or campaign eligibility. When the user activates the wallet delivery link, the enrollment surface resolves the token or identifier carried in the link to retrieve the associated provisioning context, evaluates a set of validity conditions—including offer expiration, token currency, duplicate issuance state, and campaign eligibility—before permitting installation to proceed, and presents a fallback or alternative path where any condition is not satisfied. Where validity conditions are met, the enrollment surface displays offer-specific content providing the user with a confirmatory view of the wallet artifact's content and terms, and renders the device-appropriate installation mechanism based on the ecosystem determination carried in the provisioning context. The enrollment surface also initializes the pre-installation lifecycle state of the pass instance at the moment the user engages with it, establishing the backend record against which subsequent installation confirmation, abandonment, and lifecycle events will be tracked. This combination of runtime validity enforcement, identity-aware content presentation, and lifecycle state initialization is what distinguishes the dynamic enrollment surface from conventional static pass delivery pages and enables the platform to maintain governance over the installation flow rather than ceding control once the delivery link has been transmitted to the user.

Wallet Lifecycle Manager. The wallet lifecycle manager is a platform subsystem responsible for maintaining, after installation, a continuing association between an installed wallet pass or wallet object and the persistent identity record, campaign record, session identifier, and lifecycle state record established during the provisioning flow, and for governing all post-installation lifecycle events—including redemption tracking, field updates, expiration, revocation, and replacement—through which the platform retains ongoing visibility into and control over the condition of the installed artifact. The wallet lifecycle manager treats the installed wallet object not as a terminal deliverable but as a stateful, platform-managed artifact whose condition is continuously tracked through a defined set of lifecycle states—including generated, offered, pre-installation, installed, updated, redeemed, expired, revoked, and replacement issued—with transitions between states governed in response to installation confirmation events, redemption signals received from downstream systems, platform-side update triggers, expiration conditions, and fraud or duplication findings. The continuing association that the wallet lifecycle manager maintains is the mechanism through which the present invention differs from conventional wallet distribution systems: by preserving the linkage between the installed artifact and the platform's identity and campaign records, the wallet lifecycle manager enables the platform to push field updates to the installed wallet object without requiring reinstallation, to receive and attribute redemption events to specific users and campaigns through the machine-readable identifiers embedded in the artifact at provisioning time, to enforce revocation and issue replacement passes in response to fraud detection or campaign rule changes, and to coordinate follow-on communications and offer issuances triggered by lifecycle state transitions. The wallet lifecycle manager coordinates with downstream integration systems including Customer Relationship Management (“CRM”) platforms, loyalty systems, venue and point-of-sale systems, analytics engines, and external Application Programming Interfaces (“APIs”), exchanging lifecycle events, redemption confirmations, and attribution data bidirectionally to ensure that the wallet artifact's lifecycle remains connected to the broader business system landscape throughout the full duration of its existence as a platform-managed object.

Provisioning Context Object. A provisioning context object is a structured data artifact assembled by the interaction control server following offer selection and device-ecosystem determination, consolidating into a single transferable record all parameters required by downstream provisioning and delivery services to generate, package, and deliver the correct wallet artifact for a specific user, session, and campaign interaction. The provisioning context object serves as the handoff mechanism between the offer selection layer and the wallet provisioning service, and its completeness and accuracy at the moment of assembly determines the fidelity of all subsequent provisioning actions: because it carries the selected offer definition, the applicable identity and session records, the resolved campaign and client context, the device ecosystem determination, and the validity and lifecycle initialization parameters, downstream services can operate without independent access to the platform's identity or campaign infrastructure, receiving everything they need to perform their function from the provisioning context object alone. The provisioning context object also serves as the governing document for the dynamic enrollment surface, which retrieves it upon token resolution to determine what offer content to display, what validity conditions to evaluate, and what installation path to present to the user. By consolidating context in a single structured artifact rather than requiring downstream services to independently query multiple platform data sources, the provisioning context object reduces latency, ensures consistency across provisioning pipeline stages, and creates a traceable record of the complete set of inputs that governed each specific wallet artifact generation event.

Lifecycle State. A lifecycle state is one of a defined set of mutually exclusive conditions that characterizes the current operational status of a pass instance within the platform's wallet object lifecycle state machine, reflecting what has happened to that artifact since its generation and governing what platform actions are permissible or triggered at any given moment. The lifecycle state machine encompasses the complete set of states through which a wallet pass or wallet object may transition—from generated, through offered, pre-installation, installed, and updated, to terminal or replacement conditions including abandoned, redeemed, expired, revoked, and replacement issued—with each transition governed by a specific triggering event and recorded in the lifecycle state record associated with the pass instance. The lifecycle state is significant not merely as a bookkeeping indicator but as an active governance mechanism: the current state of a pass instance determines whether the platform will process a received redemption event as valid or route it to an anomaly path, whether a received update trigger will cause field values to be pushed to the device or be held pending reinstallation, whether an expiration event will trigger renewal communications or silently close the record, and whether a duplicate issuance check will result in a fresh pass being generated or an existing instance being updated or reactivated instead. The platform maintains a complete, append-only history of all lifecycle state transitions for each pass instance, enabling audit and attribution workflows to reconstruct the full history of any wallet artifact from initial generation through final disposition, and enabling fraud detection systems to identify anomalous patterns in redemption or installation events that deviate from expected state machine behavior.

### Conceptual Architecture

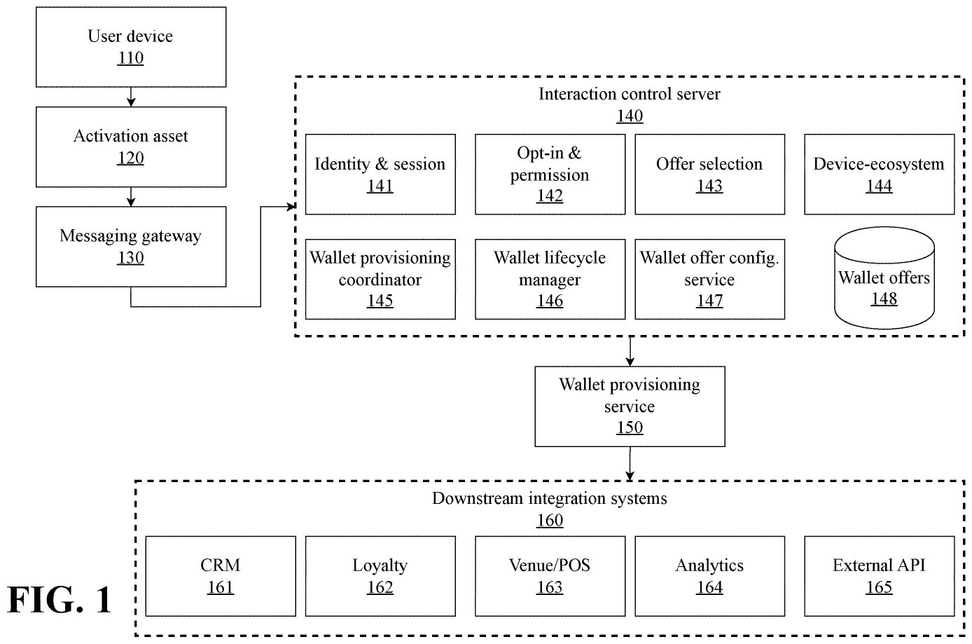

FIG. 1 is a system diagram illustrating an exemplary architecture for campaign-controlled mobile wallet offer delivery and lifecycle management. FIG. 1 begins at the user-facing edge, where a user device 110 interacts with an activation asset 120. The user device 110 may comprise a smartphone or other mobile computing device capable of receiving and installing a digital wallet pass. The activation asset 120 may comprise a QR code, redirect link, or other engagement initiator associated with a campaign or offer context. Interaction with the activation asset 120 causes the user device 110 to generate or transmit an initial message or interaction event that enters the platform.

The resulting message or event is received by the messaging gateway 130, which is communicatively coupled to both the user device 110 and the interaction control server 140. The messaging gateway 130 captures one or more user-or device-associated identifiers, such as a phone number, and routes the interaction into the platform for further processing.

The interaction control server 140 is the central orchestration component of the system and comprises a number of cooperating internal services. The identity and session service 141 retrieves or creates a persistent identity record associated with the interacting user and assigns a session identifier linking together the activation event, the messaging interaction, and all subsequent platform actions. The opt-in and permission service 142 evaluates whether the user is eligible to receive wallet-related communications and offers under applicable consent rules and campaign-specific policies. The offer selection service 143 consults one or more configured offer records together with runtime factors such as campaign state, user history, venue context, and loyalty state to determine the appropriate wallet offer for the current interaction. The device-ecosystem compatibility service 144 evaluates device environment signals to determine whether the user device 110 corresponds to a first wallet ecosystem, such as an Apple wallet environment, or a second wallet ecosystem, such as a Google wallet environment, and routes the provisioning flow accordingly. The wallet provisioning coordinator 145 directs the assembly and delivery of the wallet artifact by coordinating with the wallet offer configuration service 147, the wallet offers datastore 148, and the wallet provisioning service 150. The wallet lifecycle manager 146 maintains state records associated with provisioned and installed wallet objects and coordinates redemption tracking, pass updates, expiration, replacement, and follow-on communications over the life of the wallet artifact.

The wallet offer configuration service 147 provides the administrative and backend infrastructure through which offer definitions are created, edited, and associated with campaigns and clients. Configured offer definitions and associated mappings are persisted in the wallet offers datastore 148, which also stores issued pass instance records and lifecycle state information. Together, the wallet offer configuration service 147 and wallet offers datastore 148 supply the offer selection service 143 and wallet provisioning coordinator 145 with the structured offer data needed to generate a controlled and context-appropriate wallet artifact.

The wallet provisioning service 150 receives a provisioning context object from the interaction control server 140 and generates, packages, and delivers a wallet pass or wallet object appropriate to the determined device ecosystem. The resulting installable payload or dynamic enrollment URL is returned to the user device 110 via the messaging gateway 130, enabling the user to install the wallet object into a compatible wallet environment.

After installation, the wallet lifecycle manager 146 maintains a continuing association between the installed wallet object and the platform-side identity, campaign, session, and offer records. Lifecycle events such as redemption signals, pass updates, expiration triggers, and replacement actions are coordinated through the downstream integration systems 160, which comprise a set of external and enterprise systems that exchange lifecycle and attribution data with the interaction control server 140. These downstream systems include a CRM system 161, a loyalty system 162, a venue and point-of-sale system 163, an analytics engine 164, and one or more external APIs 165. Through these integrations, the platform preserves offer-state continuity, campaign attribution, and downstream intelligence throughout the full lifecycle of the installed wallet object.

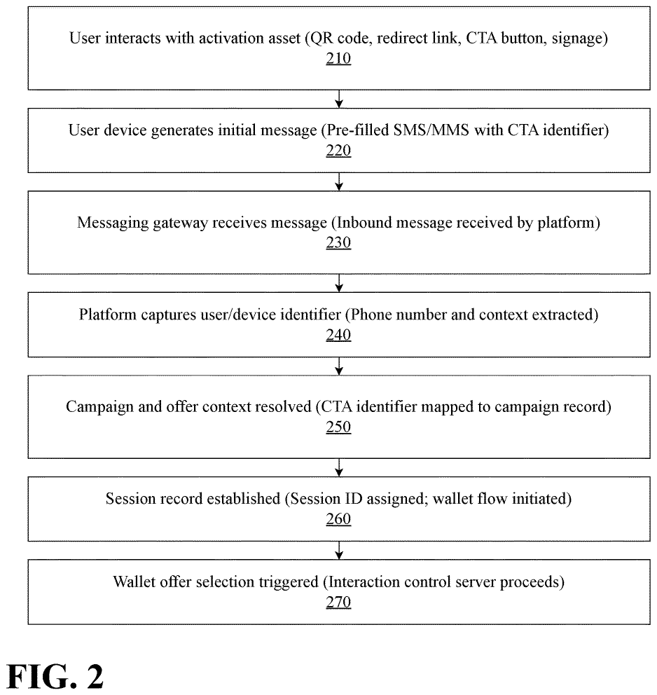

FIG. 2 is a method diagram illustrating interaction with a call to action or activation asset that initiates a messaging-driven wallet offer flow, which represents the entry sequence through which a user moves from an encounter with a physical or digital activation surface into a structured, platform-managed wallet provisioning interaction. Each step in this sequence is significant not merely as a discrete technical action but as part of a coherent thread of identity capture, context resolution, and session establishment that governs all subsequent wallet delivery and lifecycle behavior.

The method begins at step 210, where a user interacts with an activation asset such as a QR code, redirect link, call to action button, or venue signage display. The activation asset is associated with a specific campaign or offer context and is configured such that user interaction with it causes the user device to enter a platform-initiated engagement sequence. The nature of this interaction is intentionally lightweight and accessible—a user at a live venue, for example, need not download a dedicated application or navigate a complex enrollment interface. Instead, the activation asset serves as the first-stage trigger for a structured wallet provisioning flow, and the platform obtains the context it needs to manage that flow from the identifiers and payload values associated with the asset itself. In this respect, the design of the activation asset as an engagement initiator is foundational to the entire method, because the quality and specificity of the context carried through the activation event determines how precisely the platform can later select, configure, and deliver an appropriate wallet offer.

At step 220, the user device generates an initial message in response to the interaction with the activation asset, such as a pre-filled SMS or MMS message carrying one or more identifiers associated with the originating activation asset, campaign, or offer context. The pre-filled nature of the message is significant because it reduces friction for the user while ensuring that the outbound message carries the structured payload values the platform needs to resolve campaign and offer context without requiring the user to manually enter any information. The user transmits the message, completing the first leg of the interaction and transferring control to the platform.

The transmitted message is received at step 230 by the messaging gateway, which serves as the platform's inbound communication interface. The messaging gateway captures the arriving message or interaction event and makes it available to the interaction control server for further processing. This handoff from the user-facing messaging channel to the platform's internal processing infrastructure is the point at which the interaction transitions from a user-initiated action into a platform-governed workflow. The messaging gateway's role here is not merely passive transport but active capture, because it is at this stage that the platform first obtains possession of the inbound event and begins associating it with campaign and user context.

At step 240, the platform extracts one or more user-or device-associated identifiers from the received message, most commonly the phone number associated with the transmitting device, together with any contextual values carried in or inferable from the message content. The capture of a phone number or equivalent stable identifier at this step is of particular importance to the overall architecture, because it is this identifier that anchors all subsequent platform actions to a persistent user identity. Without a captured and reliable user-associated identifier at this stage, the platform would be unable to retrieve or create an identity record, prevent duplicate issuance, associate the wallet artifact with a known user context, or coordinate any lifecycle or follow-on actions after the wallet object is installed.

At step 250, the platform resolves campaign and offer context by mapping the identifier or payload carried in the initial message to one or more campaign records, client records, venue records, or offer contexts maintained by the interaction control server. This resolution step is what transforms the raw inbound message into a meaningful platform event. The system determines not only that a message was received but which campaign or activation context generated it, which client or venue is associated with it, and which class of wallet offer is implicated. The accuracy and specificity of this resolution directly governs the quality of the wallet offer selection that follows, because the resolved campaign and offer context serves as the primary input to offer selection logic.

At step 260, the platform establishes a session record linking together the originating activation asset, the captured user identifier, the resolved campaign context, and all subsequent platform decisions to be made in the course of the wallet delivery interaction. A session identifier is assigned at this step, and the wallet delivery flow is formally initiated. The session record is significant because it is the mechanism through which the platform maintains coherence across what would otherwise be a series of disconnected technical actions. By binding the activation event, the user identifier, and the campaign context into a single traceable session, the platform ensures that later actions—including wallet offer selection, pass provisioning, installation confirmation, redemption tracking, and follow-on communications—can all be attributed to and governed by the same originating interaction.

At step 270, wallet offer selection is triggered, and the interaction control server proceeds to evaluate one or more configured offer definitions and runtime factors to determine the appropriate wallet offer for the current user and interaction context. This step represents the conclusion of the initiation phase of the wallet delivery flow and the beginning of the offer determination and provisioning phase.

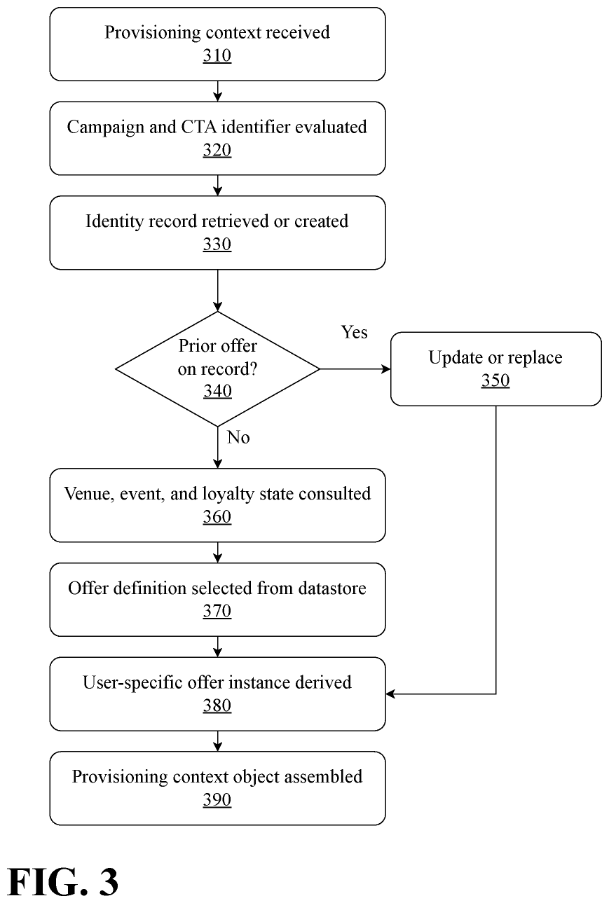

FIG. 3 is a method diagram illustrating the wallet offer selection logic executed by the interaction control server upon receipt of a provisioning context from the initiation flow. The method depicted in FIG. 3 represents one of the most consequential decision sequences in the overall platform architecture, because it is through this process that a generic inbound interaction is transformed into a precisely selected, identity-aware, and campaign-governed wallet offer instance. Rather than retrieving a static promotional artifact from a fixed catalog, the platform evaluates a combination of campaign state, user history, venue and event context, and loyalty state to determine what offer is most appropriate for the current user at the current moment. The output of this method is not merely an offer identifier but a fully assembled provisioning context object that encapsulates everything downstream services need to generate, package, and deliver the correct wallet artifact.

The method begins at step 310, where the provisioning context is received by the offer selection service from the interaction control server. This provisioning context carries the session identifier, the captured user-or device-associated identifier, and the resolved campaign and CTA values established during the initiation flow, and it serves as the structured input against which all subsequent evaluation steps in this method are performed.

At step 320, the campaign and call to action identifier are evaluated to establish the primary offer category and campaign scope applicable to the current interaction. The campaign identifier narrows the universe of potentially applicable offer definitions and establishes the client, product, venue, or event context within which the remaining selection logic will operate. This step ensures that the offer selection process is bounded by the intent of the originating campaign rather than ranging freely across all configured offer definitions in the datastore.

At step 330, the platform retrieves or creates an identity record associated with the user whose identifier was captured during the initiation flow. Where a persistent identity record already exists, the platform gains access to accumulated contextual intelligence including prior campaign interactions, previously issued wallet passes, redemption history, loyalty state, and device associations. Where no prior record exists, a new identity profile is created and initialized with the available session and campaign context. The availability of a rich identity record at this stage is what distinguishes the platform's offer selection capability from a conventional static offer lookup, because it enables the system to reason over the user's history and relationship with the platform rather than treating each interaction as an anonymous event.

The method then proceeds to the decision at step 340, where the platform determines whether a prior offer associated with the same campaign or offer category is already on record for the identified user. If a prior offer is found, the method proceeds to step 350, where the platform determines whether the existing offer should be updated or replaced rather than reissued as a duplicate. This branch of the method is important because it prevents blind reissuance of identical wallet artifacts to users who already hold a valid or recently expired instance, and it allows the platform to substitute a more contextually appropriate offer—such as a renewal, an upgraded variant, or a replacement for an expired pass—in lieu of a simple repeat delivery. The update or replacement determination at step 350 may itself depend on the current lifecycle state of the prior offer instance, the campaign rules governing reissuance, and the user's engagement history.

If no prior offer is found at step 340, or after the update or replacement path at step 350 has been resolved, the method continues to step 360, where venue, event, and loyalty state are consulted. At this step the platform evaluates whether the current interaction is associated with a specific venue, event, or physical context that should influence offer selection, and whether the user's loyalty tier, point balance, prior attendance history, or reward state entitles them to a variant offer different from the default campaign offer. This step allows the same activation asset and campaign identifier to yield meaningfully different wallet offers depending on who is interacting and under what circumstances, which is a key architectural advantage of the platform's runtime offer selection approach over conventional static offer distribution.

At step 370, an offer definition is selected from the wallet offer datastore based on the full set of evaluated factors. The selected offer definition may correspond to a reusable template applicable to multiple users, or it may be a more narrowly scoped definition associated with a specific venue, event, loyalty tier, or user segment. At step 380, a user-specific offer instance is derived from the selected offer definition, incorporating any identity-linked, session-linked, or context-linked parameters that should be reflected in the wallet artifact ultimately delivered to the user. This derivation step is what allows the platform to issue wallet passes that are individually associated with specific users and interactions rather than being identical copies of a generic promotional file.

At step 390, the provisioning context object is assembled, consolidating the selected offer definition, the applicable identity and session records, the campaign and client context, validity parameters, lifecycle initialization values, and any wallet-ecosystem assumptions or constraints established during the selection process. This provisioning context object is then supplied to downstream services responsible for generating, packaging, and delivering the wallet artifact, as further described in connection with the wallet provisioning service architecture.

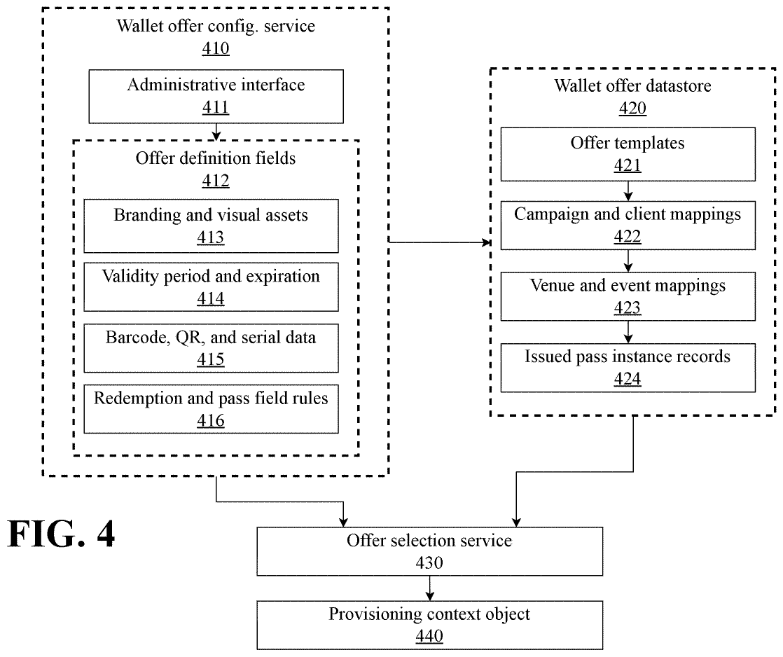

FIG. 4 is a block diagram illustrating an exemplary wallet offer configuration service and associated wallet offer datastore, together with the downstream offer selection service and provisioning context object to which configured offer data is supplied. The architecture depicted in FIG. 4 represents the backend infrastructure through which wallet offers are authored, organized, and made available for runtime selection and delivery. Rather than treating wallet offers as static files or fixed promotional artifacts, the platform maintains a structured configuration layer in which offer definitions are composed of discrete, independently configurable fields and are associated with one or more campaign, client, venue, or event contexts. This architecture is what enables the offer selection logic to retrieve and instantiate precise, context-appropriate wallet artifacts at runtime rather than distributing generic content uniformly across all users and interactions.

The wallet offer configuration service 410 is the top-level service through which offer definitions are created, edited, stored, and managed. Access to this service is provided through an administrative interface 411, through which platform operators or client users may compose and maintain offer definitions, associate them with campaigns and clients, and configure the behavioral and presentational parameters that will govern how the resulting wallet artifact appears and functions on a user device. The administrative interface 411 is the surface through which the platform's offer library is built and maintained over time, and its design as a backend configuration layer rather than a per-interaction authoring tool allows offer definitions to be reused, versioned, and selectively applied across many users and campaigns without requiring manual intervention at the moment of delivery.

Within the wallet offer configuration service 410, each offer definition is composed of a set of offer definition fields 412 that collectively specify the content, appearance, and behavioral rules of the resulting wallet artifact. The branding and visual assets field 413 captures the client-specific or campaign-specific visual identity to be applied to the wallet pass, including logos, background colors, strip images, and other presentational elements that distinguish one issuer's wallet artifact from another. The validity period and expiration field 414 governs the temporal boundaries within which the wallet artifact remains active and redeemable, allowing the platform to enforce time-limited promotions, event-specific windows, or rolling validity periods without requiring manual intervention after issuance. The barcode, QR, and serial data field 415 specifies the machine-readable payload to be embedded in the wallet pass, including the barcode format, the encoded value, and any serial or instance identifiers needed to associate a scanned pass with a specific issuance record in the platform's backend. The redemption and pass field rules 416 define the conditions under which the wallet artifact may be redeemed, the display fields to be shown on the front and back of the pass, and any update or lifecycle policies that should govern the pass after installation.

The wallet offer datastore 420 stores the output of the wallet offer configuration service 410 and organizes configured offer data into a set of structured records that the offer selection service can efficiently query at runtime. Offer templates 421 represent reusable offer definitions that may be instantiated multiple times across different users, sessions, or campaigns without requiring a new configuration to be authored for each issuance. Campaign and client mappings 422 associate each offer template or offer definition with one or more campaign identifiers and client records, allowing the offer selection logic to rapidly narrow the applicable offer universe based on the campaign context resolved during the initiation flow. Venue and event mappings 423 further associate offer definitions with specific physical or temporal contexts, enabling the platform to serve venue-specific or event-specific offer variants to users whose interaction context indicates an association with a particular location or occasion. Issued pass instance records 424 store the individual pass instances that have been derived from offer templates and issued to specific users, capturing instance-level identifiers, issuance timestamps, lifecycle state, and identity associations that allow the platform to reason over the history of a given offer across its entire user population.

The offer selection service 430 receives the provisioning context assembled during the initiation flow and queries the wallet offer datastore 420 to identify the offer definition or template most appropriate to the current user, campaign, venue, and session context. The offer selection service 430 applies the selection logic described in connection with FIG. 3, evaluating campaign and client mappings 422, venue and event mappings 423, and issued pass instance records 424 to determine whether a fresh issuance, an update, or a replacement is warranted for the identified user. Upon completing that evaluation, the offer selection service 430 produces a provisioning context object 440 that consolidates the selected offer definition, the applicable identity and session records, the resolved campaign and client context, and the validity and lifecycle parameters needed by downstream provisioning and delivery services to generate and deliver the correct wallet artifact to the user's device.

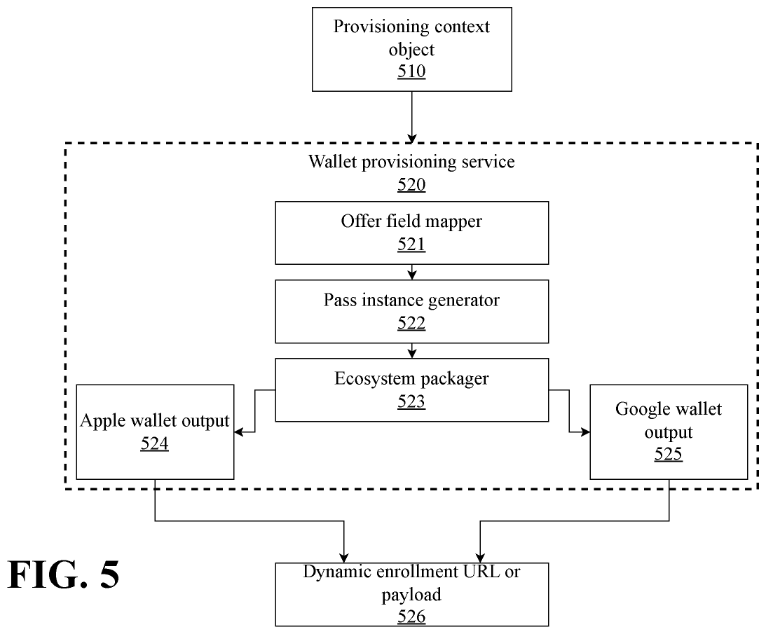

FIG. 5 is a block diagram illustrating an exemplary wallet provisioning service configured to receive a provisioning context object and generate, package, and deliver a wallet pass or wallet object appropriate to the user's device ecosystem. The architecture depicted in FIG. 5 represents the technical layer at which abstract offer definitions and session-bound context values are transformed into concrete, installable wallet artifacts. It is at this stage that the platform moves from offer selection and configuration into the actual construction of a wallet-compatible object, and the design of the wallet provisioning service as a structured, multi-stage pipeline ensures that the resulting artifact is not merely a generic pass file but a precisely assembled, identity-linked, and ecosystem-appropriate provisioning output.

The wallet provisioning service 520 receives as its primary input the provisioning context object 510, which carries the selected offer definition, the applicable identity and session records, the resolved campaign and client context, and the validity and lifecycle parameters assembled during the offer selection process. The provisioning context object 510 is the structured handoff between the offer selection layer and the provisioning layer, and its contents govern every subsequent decision made within the wallet provisioning service 520 regarding what the wallet artifact will contain, how it will be packaged, and through what path it will be delivered.

Within the wallet provisioning service 520, the provisioning pipeline begins with the offer field mapper 521, which receives the logical offer definition carried in the provisioning context object 510 and maps its fields into the data structures required for wallet pass construction. This mapping step is necessary because the offer definition as stored in the wallet offer datastore is expressed in platform-internal terms, while the wallet artifact must ultimately conform to the technical specifications of one or more wallet ecosystems. The offer field mapper 521 translates branding assets, descriptive text, validity parameters, barcode payloads, serial identifiers, redemption rules, and pass field values from their platform representation into the structured format expected by downstream packaging components. The accuracy and completeness of this mapping is significant because any mismatch between the platform's offer definition and the wallet ecosystem's field requirements could result in a malformed pass, a failed installation, or a wallet artifact that does not correctly represent the intended offer.

The pass instance generator 522 receives the mapped field values from the offer field mapper 521 and constructs a discrete, individually identified pass instance corresponding to the current user, session, and issuance event. Each pass instance generated at this stage is assigned one or more unique identifiers—such as a serial number, barcode payload, or session-linked token—that allow the platform to associate the resulting wallet artifact with a specific backend record and to distinguish it from other instances derived from the same offer template. The creation of a unique pass instance at this stage is what enables the platform's downstream lifecycle management capabilities, including redemption tracking, duplicate prevention, update delivery, and expiration enforcement, all of which depend on the ability to identify and address a specific issued pass instance rather than a generic offer category.

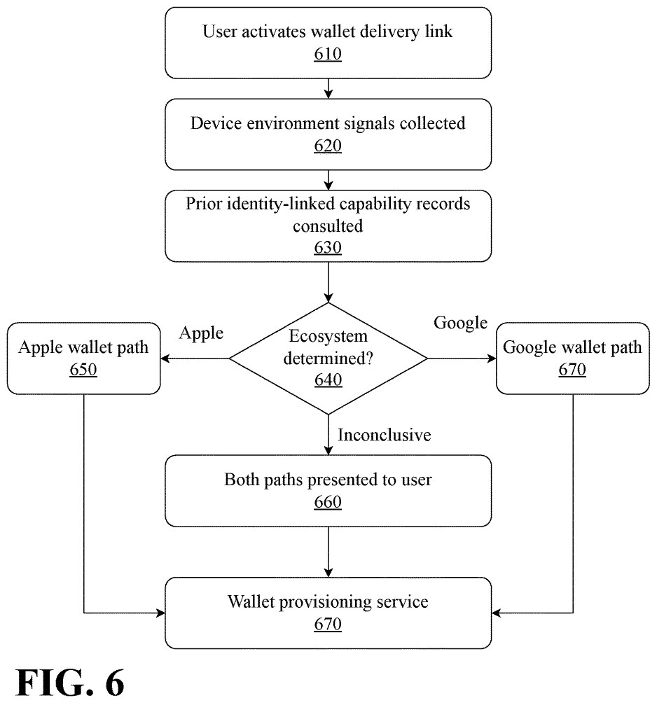

The ecosystem packager 523 receives the constructed pass instance from the pass instance generator 522 and packages it into the format required by the wallet ecosystem appropriate to the user's device, as determined by the device-ecosystem compatibility evaluation described in connection with FIG. 6. Where the user's device is associated with a first wallet ecosystem, the ecosystem packager 523 produces an Apple wallet output 524 conforming to the technical specifications of that environment. Where the user's device is associated with a second wallet ecosystem, the ecosystem packager 523 produces a Google wallet output 525 conforming to the specifications of that environment instead. The ecosystem packager 523 therefore functions as the point at which a single logical wallet artifact diverges into ecosystem-specific technical outputs, allowing the platform to serve a consistent offer experience across a diverse device population without requiring separate offer authoring or configuration for each ecosystem.

The outputs of the ecosystem packager 523, whether in the form of an Apple wallet output 524 or a Google wallet output 525, are then exposed to the user through a dynamic enrollment URL or payload 526. This dynamic enrollment URL or payload 526 is the user-facing delivery mechanism through which the installable wallet artifact is made accessible, and it is constructed to carry or reference the provisioning context in a manner that allows the platform to enforce validity conditions, prevent unauthorized reuse, and initialize lifecycle state at the moment the user proceeds through installation. The dynamic enrollment URL or payload 526 is subsequently transmitted to the user device via the messaging gateway, enabling the user to complete wallet installation through the appropriate wallet environment on their device.

FIG. 6 is a method diagram illustrating device-ecosystem compatibility determination and the selection between alternative wallet installation paths. The method depicted in FIG. 6 addresses one of the more practically significant challenges in mobile wallet provisioning, which is that different classes of user devices support fundamentally different wallet environments and require different pass formats, packaging approaches, and installation mechanisms. Rather than exposing a generic offer page and leaving the user to determine which wallet environment applies to their device, the platform performs a structured, runtime determination of device ecosystem compatibility and uses that determination to route the user into the most appropriate installation path. This device-aware routing is consequential not only for user experience but for backend provisioning logic, because the ecosystem determination made during this method governs what the wallet provisioning service generates and packages for the current interaction.

The method begins at step 610, where the user activates the wallet delivery link transmitted to their device during the response message phase of the interaction flow. This activation event is the trigger through which the platform gains its first direct opportunity to observe characteristics of the user's device environment, and it initiates the compatibility determination sequence that governs the remainder of the method.

At step 620, device environment signals are collected from the incoming request generated by the user's activation of the wallet delivery link. These signals may include device type, mobile operating system, browser identity and version, user-agent values, application container characteristics, and other environment metadata observable at the time the request reaches the platform. The collection of these signals is significant because the reliability of the subsequent ecosystem determination depends directly on the quality and completeness of the environmental data available at this step. A rich and consistent set of device signals enables a high-confidence ecosystem determination, while sparse or ambiguous signals may require the platform to fall back on alternative inference strategies or to present both installation paths to the user.

At step 630, the platform consults prior identity-linked capability records associated with the user's phone-number-anchored identity profile. Where the user has previously interacted with the platform through the same device or the same identity record, the system may have stored observations about the device class, operating system, or wallet ecosystem historically associated with that identity. Consulting these prior records at this step allows the platform to supplement or validate the signals collected at step 620 with accumulated historical intelligence, improving the accuracy of the ecosystem determination in cases where the current request signals alone would be insufficient to reach a confident conclusion.

The method then proceeds to the decision at step 640, where the platform determines whether the device ecosystem can be identified with sufficient confidence based on the collected signals and prior capability records. If the device environment signals and identity-linked records indicate that the user's device corresponds to a first wallet ecosystem, the method proceeds to the Apple wallet path 650, through which the platform routes the user into an installation flow appropriate to that environment and instructs the wallet provisioning service to generate and expose an Apple-compatible wallet artifact. If the signals instead indicate that the user's device corresponds to a second wallet ecosystem, the method proceeds to the Google wallet path 660, and the platform routes the user into the corresponding installation flow with a Google-compatible provisioning output. Where the ecosystem determination is inconclusive—due to ambiguous signals, an unrecognized device environment, or conflicting historical records—the method proceeds to step 660, where both installation paths are presented to the user simultaneously, allowing the user to manually select the wallet environment applicable to their device.

Regardless of which path is taken, all branches of the method converge on the wallet provisioning service 670, which receives the ecosystem determination as part of the provisioning context and uses it to generate, package, and expose the appropriate wallet artifact for the identified or user-selected environment. In this manner, the device-ecosystem compatibility determination performed in FIG. 6 functions not as an isolated routing decision but as a governing input to the provisioning pipeline, ensuring that the wallet artifact ultimately delivered to the user is technically compatible with their device environment and correctly packaged for installation into the appropriate wallet platform.

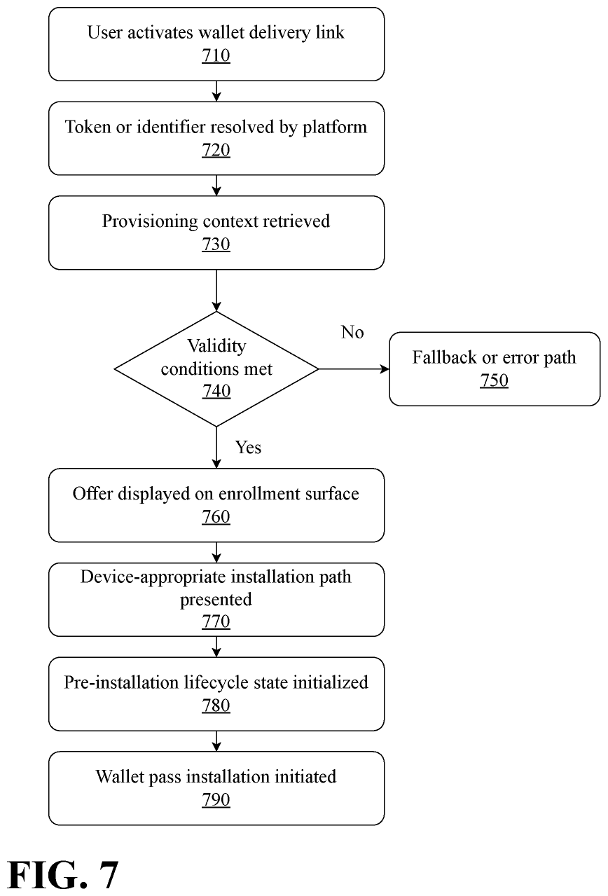

FIG. 7 is a method diagram illustrating the dynamic wallet enrollment URL and provisioning surface through which a user proceeds from activation of a controlled wallet delivery link to initiation of wallet pass installation. The method depicted in FIG. 7 represents the critical junction between the platform's backend offer selection and provisioning logic on one hand and the user-facing installation experience on the other. The dynamic enrollment surface is not a static landing page but a runtime-controlled provisioning interface whose behavior, content, and available installation paths are all determined by platform-side logic evaluated at the moment the user arrives. This design ensures that the enrollment experience presented to each user reflects the current state of their session, their identity record, their device environment, and the validity conditions governing the offer they have been issued, rather than presenting a uniform experience that is indifferent to those factors.

The method begins at step 710, where the user activates the wallet delivery link that was transmitted to their device as part of the platform's response message. This activation generates a request to the platform that carries or references one or more tokens or identifiers embedded in or associated with the wallet delivery link at the time it was constructed. The activation of the link is the event through which the user signals intent to proceed with wallet installation, and it is the trigger for the platform's runtime evaluation of the validity and context conditions that will govern what the user is shown and what installation path is made available.

At step 720, the platform resolves the token or identifier carried in or referenced by the activated link. This resolution step is significant because the wallet delivery link is not a generic URL pointing to a fixed resource but a controlled reference whose value is meaningful only in the context of the platform's backend provisioning records. By resolving the token at this step, the platform can determine which provisioning session, which user identity, and which offer instance the incoming request corresponds to, without exposing sensitive session or identity data directly in the URL itself. In some embodiments, the token may be time-limited or signed to prevent unauthorized reuse or tampering, and resolution of an expired or invalid token at this step would cause the method to route the user to the fallback or error path rather than proceeding with installation.

At step 730, the platform retrieves the provisioning context associated with the resolved token or identifier. The provisioning context carries the selected offer definition, the user identity and session records, the campaign and client context, the device ecosystem determination, and the validity and lifecycle parameters assembled earlier in the interaction flow. Retrieving this context at step 730 gives the enrollment surface everything it needs to present the correct offer, enforce applicable conditions, and initialize the appropriate installation path for the current user and device environment.

The method then proceeds to the decision at step 740, where the platform evaluates whether the validity conditions governing the current offer and provisioning session are satisfied. These conditions may include whether the offer has expired, whether the provisioning token remains within its validity window, whether the user has already installed a duplicative pass instance, whether applicable permission or consent conditions are met, and whether any campaign or venue conditions required for offer delivery remain active. The evaluation of validity conditions at this step functions as an enforcement gate that prevents the platform from proceeding with installation in circumstances where doing so would be inconsistent with campaign rules, lifecycle state, or user eligibility requirements. If one or more validity conditions are not satisfied, the method proceeds to the fallback or error path 750, through which the platform may present an updated offer, an informational notice, a support path, or an alternative enrollment option appropriate to the specific condition that was not met.

If all validity conditions are satisfied at step 740, the method continues to step 760, where the selected offer is displayed on the enrollment surface. The enrollment surface presents one or more offer-specific content elements to the user, which may include branding, descriptive text, validity information, venue or event references, redemption conditions, and other contextual details that give the user a confirmatory view of what the wallet artifact will contain before installation is initiated. This display step is important both for user experience and for informed consent, as it ensures that the user understands what they are about to install and under what conditions the resulting wallet object will be valid and redeemable.

At step 770, the device-appropriate installation path is presented to the user based on the ecosystem determination carried in the retrieved provisioning context. The enrollment surface renders the installation controls, instructions, and interface elements appropriate to the user's wallet environment, presenting an Apple wallet installation mechanism where the device corresponds to that ecosystem and a Google wallet installation mechanism where the device corresponds to the other. This step reflects the outcome of the device-ecosystem compatibility determination described in connection with FIG. 6 and translates that backend routing decision into a concrete and appropriately tailored user-facing installation interface.

At step 780, the platform initializes the pre-installation lifecycle state associated with the current pass instance. This initialization creates or updates one or more backend records indicating that the wallet offer has been viewed, that an installation has been initiated, and that a specific pass instance is now in an active pre-installation state associated with the current user, session, and campaign context. The initialization of lifecycle state at this step is consequential because it establishes the backend record against which all subsequent lifecycle events—including installation confirmation, redemption, update, expiration, and replacement—will be tracked and attributed. Without this initialization, the platform would have no reliable mechanism for distinguishing between a pass instance that was offered and installed, one that was offered and abandoned, or one that was offered but never activated.

At step 790, wallet pass installation is initiated, and the user proceeds through the ecosystem-specific installation sequence to add the wallet pass or wallet object to their device's wallet environment. The completion of installation triggers a transition in the lifecycle state record initialized at step 780, marking the pass instance as installed and making it available for the continuing lifecycle management, redemption tracking, and follow-on communication capabilities described in subsequent figures.

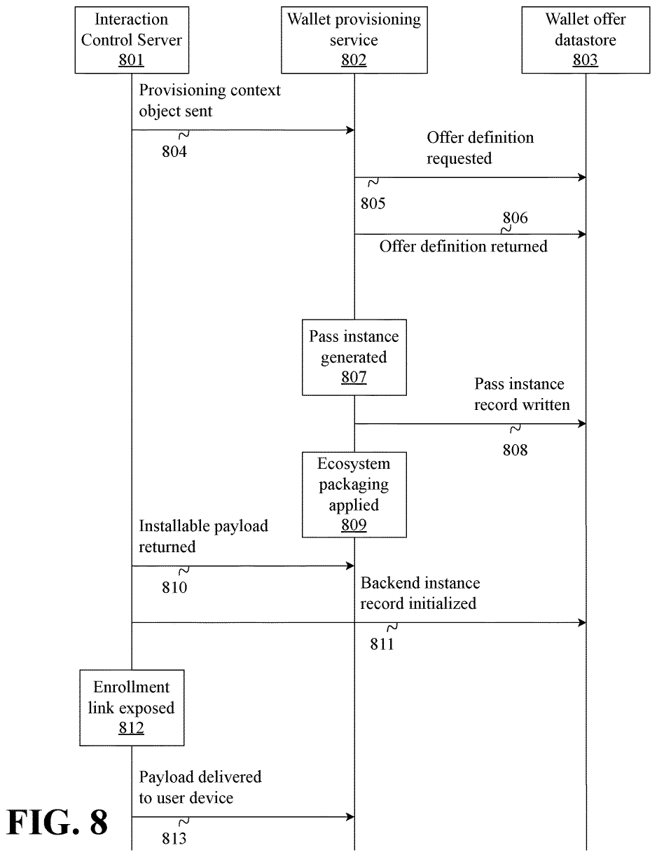

FIG. 8 is a sequence diagram illustrating the interactions among the interaction control server 801, the wallet provisioning service 802, and the wallet offer datastore 803 through which a provisioning context object is transformed into an installable wallet artifact and delivered to the user device. The sequence depicted in FIG. 8 represents the core technical execution of the wallet provisioning pipeline, and it is through this sequence that the platform's earlier decisions regarding offer selection, identity association, and device-ecosystem compatibility are operationalized into a concrete, packaged, and backend-linked wallet pass instance. Each message exchanged in this sequence serves a specific purpose in ensuring that the resulting wallet artifact is correctly constructed, individually identified, durably recorded, and properly exposed for user installation.

The sequence begins with message 804, in which the interaction control server 801 transmits the provisioning context object to the wallet provisioning service 802. The provisioning context object carries the full set of parameters assembled during offer selection and device-ecosystem determination, including the selected offer definition, the applicable identity and session records, the campaign and client context, the target wallet ecosystem, and the validity and lifecycle parameters that will govern the resulting pass instance. The transmission of this context object is the handoff event through which the interaction control server 801 delegates the technical construction of the wallet artifact to the wallet provisioning service 802, and the completeness and accuracy of the provisioning context object at this point determines the fidelity of everything that follows.

Upon receiving the provisioning context object, the wallet provisioning service 802 issues message 805, requesting the relevant offer definition from the wallet offer datastore 803. This request allows the wallet provisioning service 802 to retrieve the full structured offer definition associated with the selected offer, including all configured field values, branding assets, validity parameters, barcode and serial specifications, and redemption rules that will be mapped into the wallet artifact. The wallet offer datastore 803 responds with message 806, returning the requested offer definition to the wallet provisioning service 802. The return of the offer definition at this step gives the provisioning service the complete and authoritative source data it needs to begin constructing the wallet artifact, ensuring that the pass is built from the platform's canonical offer configuration rather than from any partial or cached representation.

With the offer definition in hand, the wallet provisioning service 802 executes the pass instance generation step represented by message 807, in which a discrete and individually identified pass instance is constructed from the mapped offer field values. The pass instance generated at this step is assigned one or more unique identifiers, such as a serial number, barcode payload, or session-linked token, that associate the resulting wallet artifact with the specific user, session, and issuance event for which it is being generated. The uniqueness of the pass instance is essential to the platform's downstream lifecycle management capabilities, as it is the individual instance identifier that allows the system to track installation, detect duplicates, attribute redemption events, deliver updates, and enforce expiration for this specific issued artifact rather than for the offer category as a whole.

The wallet provisioning service 802 then writes the newly generated pass instance to the wallet offer datastore 803 via message 808, creating a persistent pass instance record that captures the instance identifier, the associated identity and session context, the issuance timestamp, and the initial lifecycle state of the pass. This write operation is significant because it establishes the backend record against which all subsequent lifecycle events will be tracked. Without this record, the platform would have no reliable basis for confirming installation, preventing duplicate issuance, processing redemption events, or coordinating pass updates and replacements after the wallet artifact has been delivered to the user device.

Following the pass instance record write, the wallet provisioning service 802 applies ecosystem-specific packaging to the generated pass instance as represented by message 809, transforming the platform-internal pass representation into the technical format required by the target wallet ecosystem identified in the provisioning context object. This packaging step produces the installable payload that will ultimately be delivered to the user, whether in the form of an Apple wallet-compatible pass package or a Google wallet-compatible enrollment object, and it ensures that the wallet artifact conforms to the technical specifications of the destination ecosystem.

The installable payload produced by the ecosystem packaging step is then returned to the interaction control server 801 via message 810. Upon receiving the installable payload, the interaction control server 801 initializes the backend instance record via message 811, updating the platform's session and identity records to reflect that a pass instance has been packaged and is now in an active pre-installation state. This initialization step, performed by the interaction control server 801 rather than the wallet provisioning service 802, ensures that the lifecycle state of the pass instance is governed by the same component that manages identity, session, and campaign continuity throughout the broader interaction flow.

With the backend instance record initialized, the interaction control server 801 exposes the enrollment link as represented by message 812, constructing the dynamic enrollment URL or payload through which the user will access the installable wallet artifact. The enrollment link is not a generic URL but a controlled reference that carries or resolves to the provisioning context and installable payload assembled during this sequence, and its construction at this step reflects all of the platform-side determinations made during offer selection, ecosystem compatibility evaluation, and pass instance generation. Finally, the payload is delivered to the user device via message 813, completing the provisioning sequence and enabling the user to proceed through the ecosystem-specific installation flow to add the wallet pass or wallet object to their device's wallet environment.

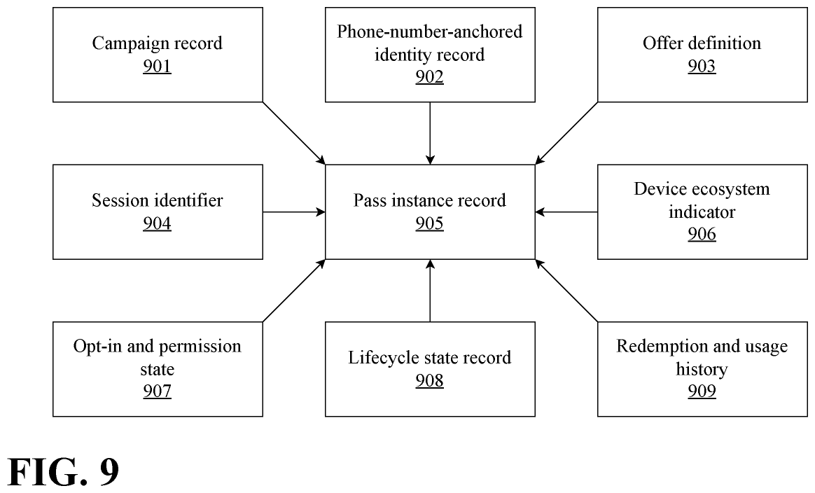

FIG. 9 is a block diagram illustrating the associations among the core data records and state indicators that collectively constitute the platform's identity-linked wallet association architecture. The diagram depicts not a sequential process but a relational structure—a set of interconnected records that together represent everything the platform knows about a specific issued wallet artifact, the user who holds it, the campaign and session through which it was delivered, and the ongoing state of the artifact across its lifecycle. This relational structure is what distinguishes the platform's approach to wallet offer delivery from conventional pass distribution systems, which typically treat the wallet artifact as a terminal deliverable with no durable backend representation. By maintaining a rich and interconnected set of associated records, the platform is able to reason over the full history and current condition of every issued pass instance, enabling identity-aware issuance decisions, duplicate prevention, lifecycle management, and coordinated follow-on engagement that would be impossible without this associative layer.

The campaign record 901 represents the originating campaign context within which the wallet offer was issued. It captures the campaign identifier, client association, offer category, and any campaign-level rules governing issuance, reissuance, validity, and follow-on behavior. The campaign record 901 serves as the highest-level contextual anchor for the pass instance, establishing the business intent and governing rules within which all subsequent platform decisions regarding the wallet artifact are made.

The phone-number-anchored identity record 902 is the persistent user-level record to which all other associations in the diagram are ultimately tied. It represents the platform's accumulated understanding of the user associated with the interacting device, including prior campaign interactions, previously issued wallet passes, communication preferences, loyalty state, and device history. The phone-number-anchored identity record 902 is the mechanism through which the platform achieves continuity across multiple sessions, campaigns, and interactions involving the same user, and it is the record that enables the platform to make identity-aware decisions at every stage of the wallet offer lifecycle rather than treating each interaction as an isolated anonymous event. The centrality of the phone-number-anchored identity record 902 in this architecture reflects the platform's foundational design principle that wallet offer delivery is not a one-time transaction but a continuing managed relationship between the platform and the user.

The offer definition 903 represents the configured wallet offer from which the current pass instance was derived. It captures the structured field values, branding assets, validity parameters, barcode and serial specifications, and redemption rules that governed the construction of the wallet artifact, and its association with the pass instance record ensures that the platform can always trace the issued artifact back to its source configuration. This association is useful not only for audit and attribution purposes but also for update and replacement logic, as the offer definition 903 provides the reference point against which any changes to pass field values or offer terms can be evaluated and applied.

The session identifier 904 links the pass instance to the specific interaction session through which it was provisioned, preserving a traceable connection between the installed wallet artifact and the activation asset interaction, messaging exchange, and provisioning sequence that produced it. The session identifier 904 is the record that allows the platform to attribute later lifecycle events—such as redemption, update, or replacement—back to the originating engagement event, which is essential for campaign analytics, attribution reporting, and fraud detection.

The pass instance record 905 is the central node of the association architecture depicted in FIG. 9, representing the individual issued wallet artifact as a discrete platform-managed object. It carries the unique instance identifier, issuance timestamp, and direct references to each of the other associated records in the diagram. All lifecycle state transitions, redemption events, and update operations performed by the platform are recorded against the pass instance record 905, making it the authoritative source of truth for the current condition and history of the issued wallet artifact. The centrality of the pass instance record 905 in this structure is intentional, as it is through this record that the platform is able to treat the wallet artifact not as an anonymous file on a user's device but as a known, individually identified, and continuously governed platform object.

The device ecosystem indicator 906 records the wallet environment into which the pass instance was installed, capturing whether the artifact was provisioned for an Apple wallet environment, a Google wallet environment, or another compatible ecosystem. This indicator is preserved as part of the pass instance's associated records because it may be relevant to future provisioning, update delivery, or recovery scenarios, such as restoring a pass after device replacement or determining the appropriate follow-up path for a user who has changed devices or operating systems since the original issuance.

The opt-in and permission state 907 reflects the user's current consent and communication eligibility status as it relates to the wallet offer and any follow-on communications associated with the installed pass instance. This record governs whether the platform may send update notifications, follow-on offers, redemption reminders, or replacement pass communications to the user, and it ensures that all post-installation engagement is conducted within the boundaries of the user's expressed preferences and applicable consent rules.

The lifecycle state record 908 captures the current state of the pass instance within the lifecycle state machine, recording whether the artifact is in a pre-installation, installed, active, redeemed, expired, revoked, or replaced state, together with a history of the transitions through which the current state was reached. The lifecycle state record 908 is the record that enables the wallet lifecycle manager to enforce state-dependent business rules, trigger appropriate follow-on actions, and maintain an accurate real-time representation of the pass instance's condition across its full lifecycle.

The redemption and usage history 909 accumulates a record of all usage and redemption events associated with the pass instance, including the timestamps, sources, and outcomes of each event reported by downstream systems such as point-of-sale platforms, venue scanners, or loyalty engines. The redemption and usage history 909 is the record that allows the platform to determine whether a pass has been consumed, how many times it has been used in multi-use scenarios, and whether any anomalous or duplicate redemption attempts have occurred, all of which inform both lifecycle state management and the platform's broader campaign analytics and fraud detection capabilities.

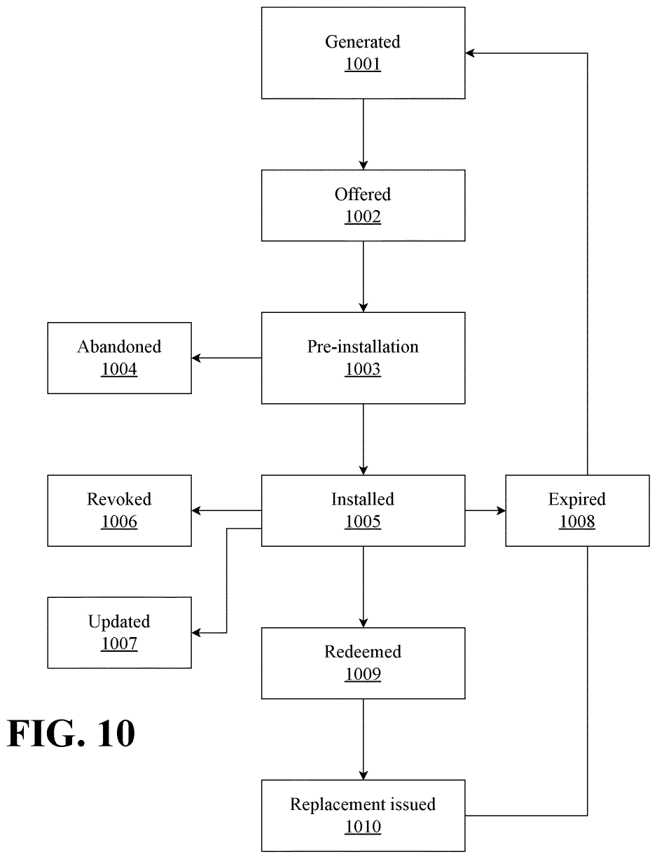

FIG. 10 is a state diagram illustrating the wallet object lifecycle state machine, depicting the full set of states through which a wallet pass or wallet object may pass from initial generation through terminal or replacement conditions, together with the transitions that govern movement between those states. The diagram depicted in FIG. 10 represents the platform's authoritative model of what a wallet artifact is at any given moment in time, and it is the conceptual foundation for the lifecycle management capabilities that distinguish the present invention from conventional wallet pass distribution systems. Rather than treating the wallet artifact as a static object whose condition is unknown to the platform after delivery, the system maintains a continuously updated lifecycle state for every issued pass instance, using that state to enforce business rules, trigger follow-on actions, prevent unauthorized reuse, and coordinate communications and downstream integrations throughout the full duration of the wallet object's existence as a platform-managed artifact.

The lifecycle begins at the generated state 1001, which is entered when the wallet provisioning service constructs a pass instance and the interaction control server initializes a corresponding backend instance record. The generated state 1001 represents the condition in which a pass instance exists as a platform-side object but has not yet been transmitted to or made available for installation by the user. This state is significant because it marks the moment at which the platform assumes responsibility for the pass instance as a discrete and individually identified artifact, regardless of whether the user ultimately proceeds through installation.

From the generated state 1001, the pass instance transitions to the offered state 1002 when the enrollment link or installable payload is transmitted to the user device and the offer is made available for the user to act upon. The offered state 1002 reflects the condition in which the platform has fulfilled its initial delivery obligation but the user has not yet taken action to install the pass. A pass instance that remains in the offered state for an extended period without user action may be subject to expiration of the delivery window or may trigger re-engagement logic, depending on campaign configuration.

From the offered state 1002, the pass instance transitions to the pre-installation state 1003 when the user activates the wallet delivery link and the dynamic enrollment surface is presented, indicating that the user has expressed active intent to proceed with installation. The pre-installation state 1003 is a transitional condition that captures the window between user engagement with the enrollment surface and confirmed completion of the wallet installation sequence. A pass instance that enters the pre-installation state 1003 but does not proceed to confirmed installation transitions instead to the abandoned state 1004, reflecting a condition in which the user initiated but did not complete the installation process. Pass instances in the abandoned state 1004 may be subject to re-engagement communications, simplified reentry flows, or expiration depending on platform and campaign configuration.

Where installation is successfully confirmed, the pass instance transitions from the pre-installation state 1003 to the installed state 1005, which represents the condition in which the wallet artifact is resident on the user's device and available for use at a point of interaction. The installed state 1005 is the primary active condition of the wallet artifact and the state from which the majority of subsequent lifecycle transitions originate. A pass instance in the installed state 1005 may transition to several different subsequent states depending on the events that occur during its active residence on the user's device.

Where a platform-side trigger or downstream event indicates that one or more fields of the installed wallet artifact should be modified—such as a loyalty point balance change, a status update, a revised expiration time, or a venue-specific modification—the pass instance transitions from the installed state 1005 to the updated state 1007. The updated state 1007 reflects the condition in which the platform has pushed one or more field changes to the installed wallet object, and the pass instance returns to the installed state 1005 following the completion of the update. This cyclical relationship between the installed state 1005 and the updated state 1007 is what enables the platform to maintain the wallet artifact as a living representation of current platform-side reality rather than a frozen snapshot of the offer as it existed at the time of installation.

From the installed state 1005, the pass instance may also transition to the revoked state 1006 where a platform-side trigger, a campaign rule, a downstream event, or a fraud or duplication determination indicates that the wallet artifact should be invalidated before it has been redeemed or expired in the ordinary course. The revoked state 1006 is a terminal condition for the specific pass instance, though revocation may trigger issuance of a replacement pass instance that enters the lifecycle at the generated state 1001, beginning a new cycle.

Where the validity window associated with the pass instance closes without redemption or revocation, the pass instance transitions from the installed state 1005 to the expired state 1008, reflecting the condition in which the offer is no longer valid for use. The expired state 1008 is a terminal condition for the pass instance itself, though it may trigger follow-on communications such as renewal offers, replacement passes, or re-engagement messages directed to the associated user identity record.

Where a redemption or usage event is received and validated by the platform, the pass instance transitions from the installed state 1005 to the redeemed state 1009, reflecting the condition in which the offer has been consumed, in whole or in part, at a point of interaction. The redeemed state 1009 may itself trigger a transition to the replacement issued state 1010, where campaign rules, loyalty logic, or downstream business rules indicate that a follow-on offer, a renewal pass, or a replacement wallet artifact should be issued to the same user. The replacement issued state 1010 initiates a new pass instance lifecycle beginning at the generated state 1001, preserving the identity, session, and campaign associations of the original pass instance in the records governing the new one.

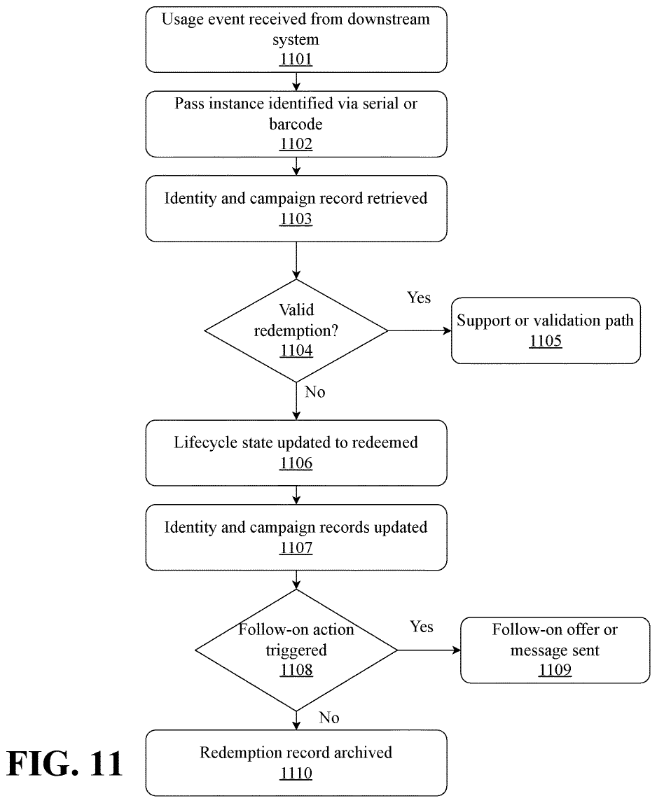

FIG. 11 is a method diagram illustrating the redemption and usage tracking flow through which the platform receives, validates, and processes a usage event reported by a downstream system, updates the lifecycle state of the associated pass instance, and determines whether one or more follow-on actions should be triggered. The method depicted in FIG. 11 represents the platform's operational response to the most consequential event in the wallet artifact's post-installation lifecycle—the moment at which the user presents or uses the installed wallet object at a point of interaction. The ability to receive, attribute, and act upon redemption events in a structured and identity-aware manner is one of the defining capabilities of the present invention, and it is through this method that the platform transforms what would otherwise be an isolated device-level interaction into a meaningful and recorded platform event with consequences for lifecycle state, campaign attribution, identity records, and future engagement strategy.

The method begins at step 1101, where a usage event is received from a downstream system. Such a downstream system may comprise a point-of-sale platform, a venue scanner, a loyalty engine, a merchant system, an event-entry system, or any other external or enterprise system capable of detecting and reporting an interaction with the wallet artifact. The receipt of a usage event at this step is the trigger for the entire tracking and attribution sequence that follows, and the platform's ability to receive such events from a variety of downstream sources is important to the breadth of contexts in which the wallet artifact may be used and tracked. The platform does not require any single mechanism for the delivery of usage events, provided that the event carries sufficient information to identify the pass instance that was used and the nature of the interaction that occurred.

At step 1102, the platform identifies the specific pass instance associated with the received usage event, using one or more identifiers embedded in or reported alongside the event, such as the serial number, barcode payload, QR data element, session-linked token, or other machine-readable reference incorporated into the wallet artifact at the time of provisioning. The identification of the specific pass instance at this step is essential because it is through this identification that the platform is able to associate the usage event with the correct backend records, including the identity record of the user who holds the pass, the campaign record under which the pass was issued, and the lifecycle state record that governs the pass instance's current condition. Without reliable pass instance identification at this step, the platform would be unable to attribute the usage event accurately or to take any of the subsequent lifecycle management actions that depend on knowing precisely which issued artifact was involved.

At step 1103, the platform retrieves the identity and campaign records associated with the identified pass instance. The retrieval of these records gives the platform the full contextual picture of the user and campaign implicated by the usage event, including the user's identity profile, prior interaction history, loyalty state, opt-in and permission state, and the campaign rules and offer terms under which the pass was originally issued. This contextual retrieval is significant because it ensures that the platform's response to the usage event is not a generic acknowledgment but an informed and identity-aware action governed by the specific circumstances of the issuance and the specific characteristics of the user who triggered the event.

The method then proceeds to the decision at step 1104, where the platform evaluates whether the received usage event constitutes a valid redemption. This evaluation may consider whether the pass instance is in an active installed state, whether the offer's validity window remains open, whether the pass has already been redeemed in a prior event, whether the reported interaction is consistent with the redemption conditions configured in the offer definition, and whether any anomalous or suspicious patterns are present that might indicate a duplicate or fraudulent redemption attempt. The validity determination at step 1104 is a critical enforcement gate that protects the integrity of the offer program and ensures that the platform's lifecycle records accurately reflect only legitimate usage events. Where the usage event does not satisfy the validity conditions, the method proceeds to the support or validation path 1105, through which the platform may escalate the event to a human review process, trigger a pass refresh or correction flow, or route the interaction to a customer service response appropriate to the specific condition that caused the validity check to fail.

Where the usage event is determined to be a valid redemption at step 1104, the method continues to step 1106, where the lifecycle state of the pass instance is updated to reflect the redeemed condition. This state transition is recorded in the lifecycle state record associated with the pass instance and marks the wallet artifact as having been consumed, in whole or in part, at the point of interaction. For single-use offers, this transition renders the pass instance inactive and prevents further redemption. For multi-use or loyalty-oriented wallet objects, the transition may instead update one or more usage counters or field values while leaving the pass instance in an active state eligible for further use.

At step 1107, the identity and campaign records associated with the pass instance are updated to reflect the redemption event. This update enriches the user's persistent identity profile with a record of the usage event, contributing to the accumulated contextual intelligence that will inform future offer selection, communication decisions, and loyalty state management for the same user. The campaign record is similarly updated to capture the redemption as an attribution event, providing the platform with the data needed to measure the effectiveness of the originating campaign and to report accurate conversion and usage metrics to the client or campaign operator.

The method then proceeds to the decision at step 1108, where the platform evaluates whether the redemption event should trigger one or more follow-on actions. Such follow-on actions may be defined by campaign rules, loyalty logic, downstream business rules, or event-specific configurations, and they may include sending a thank-you message, issuing a replacement or renewal pass, delivering a loyalty accrual notification, transmitting a cross-sell or upsell offer, or initiating any other communication or platform action that is appropriate given the user's identity context and the campaign's post-redemption strategy. Where a follow-on action is triggered, the method proceeds to step 1109, where the follow-on offer or message is sent to the user through the appropriate communication channel, leveraging the identity and permission records retrieved at step 1103 to ensure that the communication is delivered through a channel for which the user is eligible and in a form appropriate to the user's device and communication preferences. Where no follow-on action is triggered, or after any triggered follow-on action has been dispatched, the method concludes at step 1110, where the redemption record is archived as a permanent component of the pass instance's usage history, preserving a complete and auditable record of the usage event for campaign analytics, fraud detection, and future lifecycle management purposes.

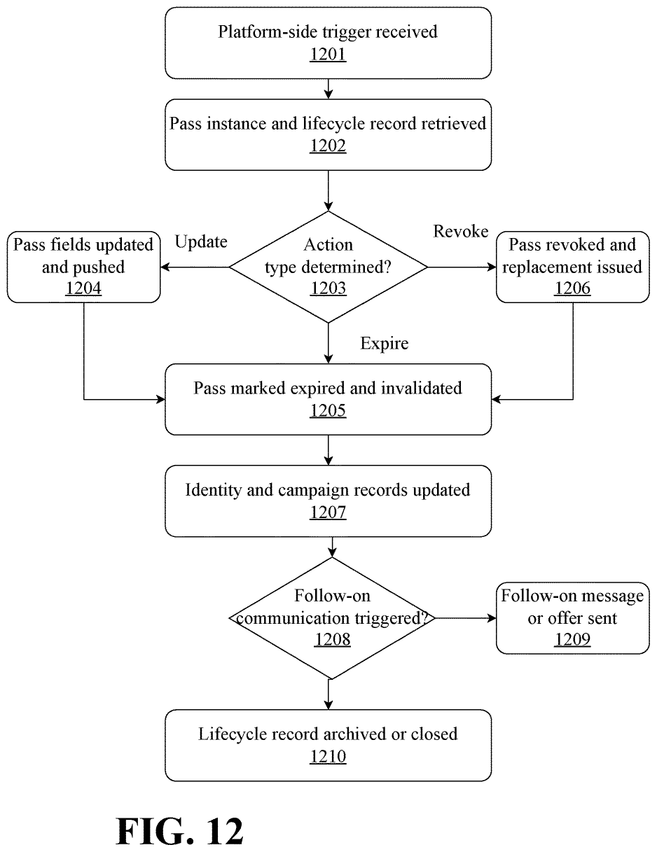

FIG. 12 is a method diagram illustrating the pass update, expiration, revocation, and replacement flow through which the platform executes platform-side lifecycle actions against an installed wallet artifact in response to internally or externally generated triggers. The method depicted in FIG. 12 represents the platform's active governance of the wallet object after installation, and it is through this method that the present invention most clearly distinguishes itself from conventional wallet pass distribution systems in which the installed artifact is effectively beyond the issuing platform's reach once it has been delivered to the user's device. By maintaining a continuing association between the installed wallet object and the platform's identity, campaign, session, and lifecycle records, the system retains the ability to modify, invalidate, replace, or retire the wallet artifact at any point in its lifecycle in response to a wide range of triggering conditions, treating the installed pass not as a static file but as a managed and continuously governable platform object.

The method begins at step 1201, where a platform-side trigger is received. Such a trigger may originate from a wide variety of sources, including a scheduled expiration event, a loyalty system reporting a point balance change, a campaign operator initiating a field update, a venue or event system reporting a change in event status, a downstream business rule evaluating the current condition of the pass instance, or a fraud or duplication detection system flagging a pass instance for revocation. The diversity of possible trigger sources reflects the breadth of circumstances under which the platform may need to act on an installed wallet artifact, and the method is designed to handle all such triggers through a common processing pipeline regardless of their origin.

At step 1202, the platform retrieves the pass instance record and the associated lifecycle record corresponding to the wallet artifact implicated by the received trigger. The retrieval of these records gives the platform a complete and current picture of the pass instance's identity associations, campaign context, current lifecycle state, prior state transitions, and any pending actions or flags that may be relevant to the processing of the current trigger. This retrieval step is important because it ensures that the action taken in response to the trigger is informed by the full history and current condition of the specific pass instance involved, rather than being applied generically or without regard to the artifact's existing state.

The method then proceeds to the decision at step 1203, where the platform determines the type of action to be taken in response to the received trigger. Three primary action types are recognized in the method: update, expire, and revoke, each of which corresponds to a distinct set of downstream operations and lifecycle state transitions. The determination of action type at step 1203 may be made based on the nature of the triggering event, the current lifecycle state of the pass instance, the campaign rules and offer terms governing the pass, and any operator or system instructions carried in or associated with the trigger itself.

Where the action type is determined to be an update, the method proceeds to step 1204, where the relevant pass fields are updated and pushed to the installed wallet artifact. This may involve modifying one or more display fields, updating a loyalty balance or status indicator, revising an expiration timestamp, replacing a barcode payload, or making any other field-level change to the installed wallet object that reflects a change in platform-side reality since the pass was last provisioned or updated. The ability to push field updates to an installed wallet artifact is a significant capability that allows the platform to keep the wallet object current and meaningful over time, ensuring that the user's device-resident pass continues to accurately represent the state of the offer, loyalty account, or entitlement it embodies rather than becoming stale or misleading as circumstances change.

Where the action type is determined to be an expiration, the method proceeds to step 1205, where the pass instance is marked as expired and invalidated in the platform's backend records. This transition reflects the condition in which the offer's validity window has closed, the event or venue to which the pass was tied has concluded, or a campaign rule has determined that the pass should no longer be available for redemption. The expiration action at step 1205 updates the lifecycle state record to reflect the expired condition and may cause the wallet artifact on the user's device to display an expired or inactive state, depending on the capabilities of the target wallet ecosystem and the field update mechanisms available for the relevant pass format.

Where the action type is determined to be a revocation, the method proceeds to step 1206, where the pass instance is revoked and a replacement pass is issued. Revocation differs from expiration in that it reflects an active platform decision to invalidate the pass instance before its natural validity window has closed, typically in response to a fraud detection event, a duplication finding, a campaign rule violation, or a downstream system instruction. The issuance of a replacement pass at step 1206 may involve initiating a new pass instance lifecycle beginning at the generated state in the lifecycle state machine, preserving the identity, session, and campaign associations of the original pass instance in the records governing the replacement. In some embodiments, the replacement pass may carry updated field values, revised terms, or a different offer variant appropriate to the circumstances that prompted the revocation.

Regardless of which action type was taken at steps 1204, 1205, or 1206, the method converges at step 1207, where the identity and campaign records associated with the pass instance are updated to reflect the lifecycle action that was performed. This update ensures that the user's persistent identity profile and the originating campaign record each carry an accurate and complete record of what happened to the pass instance and when, contributing to the accumulated contextual intelligence that governs future offer selection, communication decisions, and lifecycle management for the same user and campaign.

The method then proceeds to the decision at step 1208, where the platform evaluates whether the lifecycle action performed should trigger a follow-on communication to the user. The appropriateness of a follow-on communication at this step depends on the nature of the action taken, the user's opt-in and permission state, the campaign's post-action communication rules, and the specific circumstances that prompted the trigger. A pass update may warrant a notification informing the user that their wallet artifact has been refreshed. An expiration may prompt a renewal offer or a re-engagement message. A revocation and replacement may trigger a communication directing the user to install the replacement pass or explaining the reason for the change. Where a follow-on communication is warranted, the method proceeds to step 1209, where the follow-on message or offer is sent to the user through an appropriate communication channel consistent with the user's eligibility and permission state. Where no follow-on communication is triggered, or after any triggered communication has been dispatched, the method concludes at step 1210, where the lifecycle record is archived or closed, preserving a complete and auditable record of the trigger, the action taken, and the resulting state of the pass instance for campaign analytics, compliance, and future lifecycle management purposes.

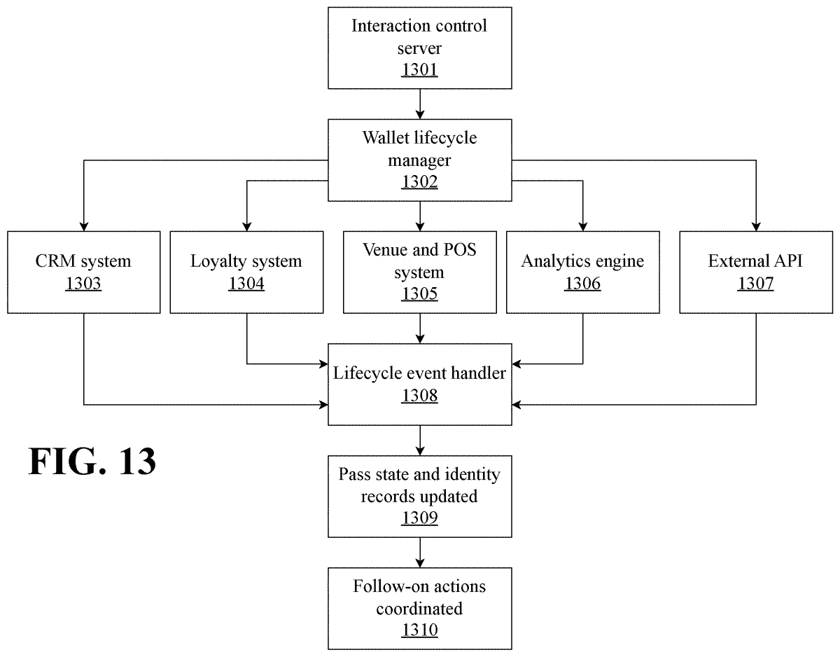

FIG. 13 is a system diagram illustrating the downstream integration architecture through which the interaction control server and wallet lifecycle manager exchange lifecycle events, redemption confirmations, attribution data, and state updates with external and enterprise systems, and through which the platform coordinates follow-on actions in response to the signals received from those systems. The architecture depicted in FIG. 13 represents the outward-facing layer of the platform's lifecycle management capability, and it is through this architecture that the wallet artifact's continuing lifecycle is connected to the broader ecosystem of business systems that have an interest in, or an ability to report on, the state and usage of the installed wallet object. The design of this integration layer as a structured and bidirectional exchange architecture, rather than a simple one-way delivery mechanism, reflects the platform's treatment of the wallet artifact as a managed object whose condition is continuously relevant to and influenced by a wide range of downstream systems and business processes.

The interaction control server 1301 sits at the top of the architecture depicted in FIG. 13 and serves as the governing component responsible for orchestrating all downstream integration activity. The interaction control server 1301 maintains the session, identity, and campaign context that gives meaning to every lifecycle event exchanged with downstream systems, and it is through this component that the platform ensures all downstream integrations are conducted within the bounds of the identity, permission, and campaign governance framework established during the original wallet delivery interaction. The interaction control server 1301 delegates the specific mechanics of lifecycle event processing to the wallet lifecycle manager 1302, which operates as a dedicated subsystem responsible for maintaining pass instance state and coordinating the receipt and dispatch of lifecycle signals with the downstream integration layer.

The wallet lifecycle manager 1302 receives lifecycle events and state change signals from the interaction control server 1301 and manages their distribution to and collection from the downstream integration systems depicted in FIG. 13. The wallet lifecycle manager 1302 is the component that maintains a current and accurate representation of each pass instance's lifecycle state, and it is the authoritative intermediary through which downstream systems report usage events and receive state-relevant information about the wallet artifacts with which they interact. By centralizing lifecycle event processing in the wallet lifecycle manager 1302, the platform ensures that all downstream integrations are subject to consistent identity association, attribution logic, and state management governance regardless of which specific downstream system is involved in a given event.

The downstream integration systems with which the wallet lifecycle manager 1302 exchanges lifecycle events include a CRM system 1303, a loyalty system 1304, a venue and point-of-sale system 1305, an analytics engine 1306, and one or more external APIs 1307. The CRM system 1303 receives campaign attribution data, redemption confirmations, and identity-linked engagement records that allow the business to maintain an accurate and up-to-date view of each customer's wallet offer history and campaign interactions within its customer relationship management infrastructure. The loyalty system 1304 exchanges loyalty state updates, point accrual events, tier change notifications, and reward redemption confirmations with the wallet lifecycle manager 1302, enabling the platform to keep the wallet artifact's displayed loyalty fields current and to respond appropriately to loyalty milestones or balance changes that should trigger pass updates or replacement offers. The venue and point-of-sale system 1305 reports usage and redemption events originating from physical interaction points such as venue scanners, merchant terminals, or event entry systems, providing the platform with the ground-truth signals it needs to update pass lifecycle state, prevent duplicate redemption, and trigger any follow-on actions associated with a confirmed point-of-interaction usage event. The analytics engine 1306 receives campaign performance data, installation and redemption metrics, ecosystem distribution records, and attribution lineage information that allow the platform and its clients to measure the effectiveness of wallet offer campaigns, optimize future offer configurations, and identify patterns in user behavior across the full wallet artifact lifecycle. The external APIs 1307 represent any additional third-party or enterprise systems that may have a role in the wallet offer lifecycle within a given deployment context, providing a flexible integration point through which the platform can accommodate the specific downstream system landscape of individual clients or campaign operators without requiring changes to the core lifecycle management architecture.

All lifecycle events, redemption signals, loyalty updates, attribution data, and state change notifications exchanged between the wallet lifecycle manager 1302 and the downstream integration systems are received and processed by the lifecycle event handler 1308. The lifecycle event handler 1308 serves as the platform's internal processing layer for incoming downstream signals, evaluating each received event against the current lifecycle state of the implicated pass instance, the identity and campaign records associated with that instance, and the business rules and campaign configurations that govern the appropriate platform response. By routing all incoming downstream signals through the lifecycle event handler 1308, the platform ensures that no downstream event results in an uncontrolled or ungoverned state change to a pass instance, and that every lifecycle transition triggered by a downstream signal is subject to the same identity-aware and campaign-governed logic that governs all other platform actions.

Following processing by the lifecycle event handler 1308, the method proceeds to step 1309, where the pass state and identity records associated with the implicated pass instance are updated to reflect the outcome of the processed event. This update ensures that the platform's canonical records for the pass instance and the associated user identity profile each accurately reflect the current condition of the wallet artifact and the full history of lifecycle events that have occurred since issuance. Finally, at step 1310, follow-on actions are coordinated in response to the processed event and updated records, encompassing any communications, replacement pass issuances, loyalty notifications, campaign attribution reports, or other platform actions that the processed event and updated state records indicate should be taken. Through this final coordination step, the downstream integration architecture depicted in FIG. 13 completes its role as the mechanism by which the platform remains continuously aware of, and continuously responsive to, everything that happens to the wallet artifact after it has been installed on the user's device.

### Exemplary Computing Environment

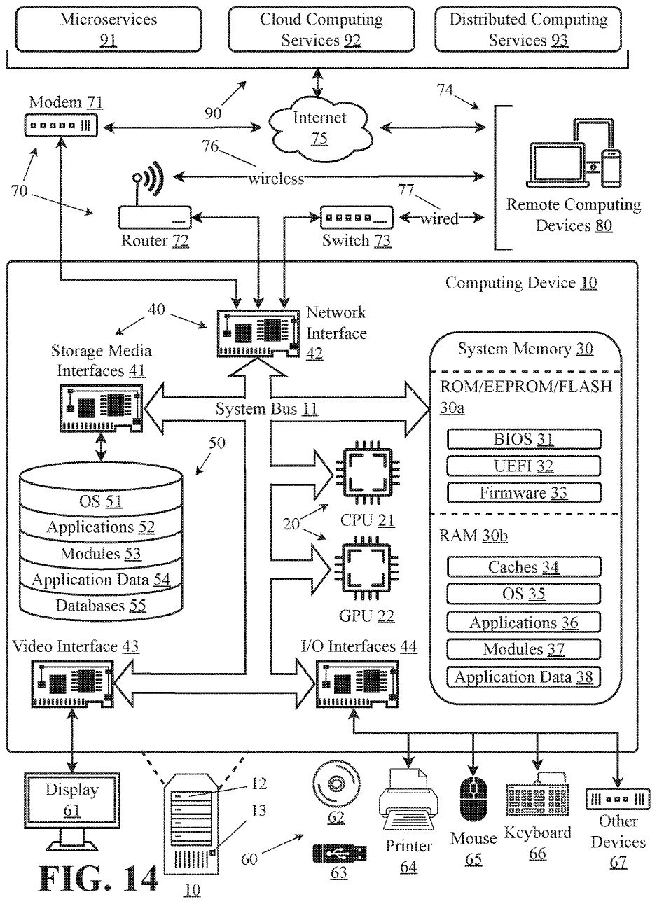

FIG. 14 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for campaign-controlled mobile wallet offer delivery and lifecycle management, the system comprising:
one or more processors and one or more non-transitory computer-readable media storing instructions that, when executed, cause the system to perform operations comprising:
receiving, at a messaging gateway, an inbound message or interaction event originating from a user device in response to user interaction with an activation asset, and capturing one or more user-or device-associated identifiers from the inbound message or interaction event;
retrieving or creating, by an interaction control server, a persistent identity record associated with the captured identifier, and resolving one or more campaign or offer contexts associated with the activation asset;
selecting, by the interaction control server, a wallet offer from one or more configured wallet offer records based at least in part on the resolved campaign or offer context and the persistent identity record;
determining, by a device-ecosystem compatibility service, a wallet ecosystem associated with the user device, and generating or selecting a wallet provisioning path appropriate to the determined wallet ecosystem;
transmitting, to the user device, a response message comprising a controlled wallet delivery link resolving to a dynamic enrollment surface through which a wallet pass or wallet object corresponding to the selected wallet offer may be installed into the determined wallet ecosystem; and
maintaining, by a wallet lifecycle manager, an association between the installed wallet pass or wallet object and one or more of the persistent identity record, a campaign record, a session identifier, and a lifecycle state record, such that the platform retains the ability to track, update, and govern the wallet pass or wallet object after installation.

2. The system of claim 1, wherein selecting the wallet offer comprises:
evaluating one or more of venue context, event context, loyalty state, prior redemption history, and prior pass issuance history associated with the persistent identity record; and
wherein the selected wallet offer is derived as a user-specific or session-specific instance from a reusable offer template stored in a wallet offer datastore.

3. The system of claim 1, wherein the dynamic enrollment surface is configured to:
evaluate one or more validity conditions before permitting installation to proceed, the validity conditions comprising one or more of:
offer expiration state;
token validity;
duplicate issuance state; and
campaign eligibility; and
wherein the dynamic enrollment surface presents a fallback or alternative path where one or more validity conditions are not satisfied.

4. The system of claim 1, wherein determining the wallet ecosystem associated with the user device comprises:
evaluating one or more of:
device type;
operating system;
browser characteristics;
user-agent values; and
prior identity-linked capability records; and
wherein the wallet provisioning path is selected from a first provisioning path associated with a first wallet ecosystem and a second provisioning path associated with a second wallet ecosystem.

5. The system of claim 1, wherein maintaining the association between the installed wallet pass or wallet object and the lifecycle state record comprises:
tracking one or more lifecycle state transitions comprising generated, offered, pre-installation, installed, redeemed, updated, expired, revoked, and replacement issued states;
and wherein transitions between states are triggered by one or more of installation confirmation events, redemption signals, downstream system notifications, platform-side triggers, and expiration conditions.

6. The system of claim 1, wherein the wallet lifecycle manager is further configured to:
receive one or more usage or redemption events from one or more downstream systems;
associate each received event with the persistent identity record and the campaign record through one or more identifiers embedded in the wallet pass or wallet object;
update the lifecycle state record accordingly; and
trigger one or more follow-on communications or offer issuances based on the updated lifecycle state.

7. The system of claim 1, wherein the wallet lifecycle manager is further configured to:
push one or more field updates to the installed wallet pass or wallet object in response to one or more:
platform-side triggers comprising loyalty state changes;
validity period modifications;
venue or event status changes; and
campaign operator instructions;
such that the installed wallet pass or wallet object reflects a current platform-side state after the update is applied.

8. The system of claim 1, wherein the interaction control server is further configured to:
evaluate a duplicate issuance condition against the persistent identity record prior to transmitting the response message; and
wherein the response message is modified to provide an update link, a replacement link, or an informational path in lieu of a new installation link where an active pass instance associated with the same identity record and campaign context is determined to exist.

9. The system of claim 1, wherein:
the activation asset comprises one or more of:
a QR code;
a redirect link;
a venue-displayed code; and
an embedded messaging control; and
wherein user interaction with the activation asset causes the user device to generate a pre-filled outbound message carrying one or more identifiers associated with the activation asset, campaign, or offer context, the transmission of which constitutes the inbound message received by the messaging gateway.

10. The system of claim 6, wherein:
the one or more downstream systems comprise one or more of:
a customer relationship management system;
a loyalty platform;
a venue or point-of-sale system;
an analytics engine; and
an external application programming interface; and
wherein lifecycle events, redemption confirmations, and attribution data are exchanged bidirectionally between the wallet lifecycle manager and the one or more downstream systems through a lifecycle event handler configured to govern all state transitions resulting from downstream signals within the platform's identity and campaign governance framework.

11. A method for campaign-controlled mobile wallet offer delivery and lifecycle management, the method comprising the steps of:
receiving an inbound message or interaction event originating from a user device in response to user interaction with an activation asset, and capturing one or more user-or device-associated identifiers from the inbound message or interaction event, using a messaging gateway;
retrieving or creating a persistent identity record associated with the captured identifier, and resolving one or more campaign or offer contexts associated with the activation asset, using an interaction control server;
selecting a wallet offer from one or more configured wallet offer records based at least in part on the resolved campaign or offer context and the persistent identity record, using an interaction control server;
determining a wallet ecosystem associated with the user device, and generating or selecting a wallet provisioning path appropriate to the determined wallet ecosystem, using a device-ecosystem compatibility service;
transmitting, to the user device, a response message comprising a controlled wallet delivery link resolving to a dynamic enrollment surface through which a wallet pass or wallet object corresponding to the selected wallet offer may be installed into the determined wallet ecosystem; and
maintaining an association between the installed wallet pass or wallet object and one or more of the persistent identity record, a campaign record, a session identifier, and a lifecycle state record, such that the platform retains the ability to track, update, and govern the wallet pass or wallet object after installation, using a wallet lifecycle manager.

12. The method of claim 11, wherein selecting the wallet offer comprises:
evaluating one or more of venue context, event context, loyalty state, prior redemption history, and prior pass issuance history associated with the persistent identity record; and
wherein the selected wallet offer is derived as a user-specific or session-specific instance from a reusable offer template stored in a wallet offer datastore.

13. The method of claim 11, wherein the dynamic enrollment surface is configured to:
evaluate one or more validity conditions before permitting installation to proceed, the validity conditions comprising one or more of:
offer expiration state;
token validity;
duplicate issuance state; and
campaign eligibility; and
wherein the dynamic enrollment surface presents a fallback or alternative path where one or more validity conditions are not satisfied.

14. The method of claim 11, wherein determining the wallet ecosystem associated with the user device comprises:
evaluating one or more of:
device type;
operating system;
browser characteristics;
user-agent values; and
prior identity-linked capability records; and
wherein the wallet provisioning path is selected from a first provisioning path associated with a first wallet ecosystem and a second provisioning path associated with a second wallet ecosystem.

15. The method of claim 11, wherein maintaining the association between the installed wallet pass or wallet object and the lifecycle state record comprises:
tracking one or more lifecycle state transitions comprising generated, offered, pre-installation, installed, redeemed, updated, expired, revoked, and replacement issued states;
and wherein transitions between states are triggered by one or more of installation confirmation events, redemption signals, downstream system notifications, platform-side triggers, and expiration conditions.

16. The method of claim 11, wherein the wallet lifecycle manager is further configured to:
receive one or more usage or redemption events from one or more downstream systems;
associate each received event with the persistent identity record and the campaign record through one or more identifiers embedded in the wallet pass or wallet object;
update the lifecycle state record accordingly; and
trigger one or more follow-on communications or offer issuances based on the updated lifecycle state.

17. The method of claim 11, wherein the wallet lifecycle manager is further configured to:
push one or more field updates to the installed wallet pass or wallet object in response to one or more:
platform-side triggers comprising loyalty state changes;
validity period modifications;
venue or event status changes; and
campaign operator instructions;
such that the installed wallet pass or wallet object reflects a current platform-side state after the update is applied.

18. The method of claim 11, wherein the interaction control server is further configured to:
evaluate a duplicate issuance condition against the persistent identity record prior to transmitting the response message; and
wherein the response message is modified to provide an update link, a replacement link, or an informational path in lieu of a new installation link where an active pass instance associated with the same identity record and campaign context is determined to exist.

19. The method of claim 11, wherein:
the activation asset comprises one or more of:
a QR code;
a redirect link;
a venue-displayed code; and
an embedded messaging control; and
wherein user interaction with the activation asset causes the user device to generate a pre-filled outbound message carrying one or more identifiers associated with the activation asset, campaign, or offer context, the transmission of which constitutes the inbound message received by the messaging gateway.

20. The method of claim 16, wherein:
the one or more downstream systems comprise one or more of:
a customer relationship management system;
a loyalty platform;
a venue or point-of-sale system;
an analytics engine; and
an external application programming interface; and
wherein lifecycle events, redemption confirmations, and attribution data are exchanged bidirectionally between the wallet lifecycle manager and the one or more downstream systems through a lifecycle event handler configured to govern all state transitions resulting from downstream signals within the platform's identity and campaign governance framework.
